(19) United States
(12) Patent Application Publication
(10) Pub. No.: US 2023/0338231 A1
(43) Pub. Date: Oct. 26, 2023

(54) Patient-Specific Cardiopulmonary Resuscitation Ramp Up Protocols

(71) Applicant: ZOLL Medical Corporation, Chelmsford, MA (US)

(72) Inventors: Paolo Giacometti, North Grafton, MA (US); Gary A. Freeman, Waltham, MA (US); Joshua W. Lampe, Groton, MA (US); Annemarie E. Silver, Bedford, MA (US)

(21) Appl. No.: 18/013,316

(22) PCT Filed: Jun. 25, 2021
(86) PCT No.: PCT/US2021/039110

§ 371 Date: Dec. 28, 2022

Related U.S. Application Data
(60) Provisional application No. 63/045,402, filed on Jun. 29, 2020.

(51) Int. Cl. A61H 31/00

(52) U.S. Cl. CPC A61H 31/006; A61H 2201/5064; A61H 2201/5007; A61H 2201/5005; A61H 2201/5058; A61H 2201/5084; A61H 2201/5079; A61H 2201/165; A61H 2201/1246

(57) ABSTRACT

A system for administering patient-specific chest compressions includes an automated chest compressor configured to be applied to the chest of the patient to administer chest compressions to the patient; at least one force sensor configured to sense force information for force exerted on the patient by the chest compressor from the applied chest compressions; and at least one processor and memory communicatively coupled with the chest compressor and the at least one force sensor. The at least one processor and memory are configured to control the chest compressor to administer the chest compressions over an initial compression period according to an initial compression protocol. The initial compression protocol includes a plurality of chest compressions of increasing scheduled depths with a first compression at an initial depth and a final compression at a final target depth greater in magnitude than the initial depth.

### CROSS REFERENCE TO RELATED APPLICATION

This application is the United States national phase of International Application No. PCT/US2021/039110 filed Jun. 25, 2021, and claims priority to U.S. Provisional Patent Application No. 63/045,402 filed Jun. 29, 2020, the disclosures each of which are hereby incorporated by reference in their entireties.

### BACKGROUND OF THE INVENTION

### Field of the Invention

The present disclosure is related to systems for providing manual or automated chest compressions to a patient and, in particular, to systems that provide chest compressions at scheduled depths according to an initial compression protocol and/or at patient-specific depths, which can be determined based on sensed motion and force information for chest compressions provided to the patient.

### Description of Related Art

For cardiac arrest patients, cardiopulmonary resuscitation (CPR) may include a variety of therapeutic interventions including chest compressions, defibrillation, and ventilation. Chest compressions during CPR may maintain blood circulation so that oxygen can be delivered to the body until the heart resumes an effective rhythm. The chest compressions may be performed by automated mechanical devices, such as, for example, the ZOLL® AutoPulse® mechanical chest compression device.

Alternatively, or additionally, chest compressions may be performed manually. During manual chest compressions, a rescuer, such as an acute care provider or lay person, places his or her hands on the patient's chest and pushes on the chest to perform the chest compression. Various devices are available for providing mechanical assistance for manual chest compressions. For example, an acute care provider may use a hand-held device, such as, for example, the ZOLL® ResQPump® active compression decompression device, positioned on the patient's chest to enhance movement of the patient's chest during chest compression and decompression.

Computer devices and systems are available for providing feedback to rescuers (e.g., acute care providers and lay persons) about chest compressions performed for a patient. Some devices provide feedback relating to characteristics of the chest compressions, such as measured values for compression depth or rate for chest compressions provided to a patient, in real-time, during the chest compressions. Such feedback may allow the acute care provider to modify and, thereby, improve the efficacy of the chest compressions. Feedback can also include instructions or notifications directing the rescuer to modify an aspect of provided chest compressions, such as a verbal or visual instruction to “Press Harder” or “Release the Chest between Chest Compressions.” Feedback may also be provided to assist acute care providers at a rescue scene to more effectively combine and coordinate the chest compressions with other resuscitative therapies. In some situations, during the initial period of chest compressions, the patient may be vulnerable to injury due to the repeated impact of the chest compression forces.

### SUMMARY OF THE INVENTION

According to an aspect of the disclosure, a system for administering patient-specific chest compressions to a patient includes an automated chest compressor configured to be applied to the chest of the patient to administer chest compressions to the patient; at least one force sensor configured to sense force information for force exerted on the patient by the chest compressor from the applied chest compressions; and at least one processor and memory communicatively coupled with the chest compressor and the at least one force sensor. The at least one processor and memory are configured to: control the chest compressor to administer the chest compressions over an initial compression period according to an initial compression protocol. The initial compression protocol includes a plurality of chest compressions of increasing scheduled depths with a first compression at an initial depth and a final compression at a final target depth greater in magnitude than the initial depth. The processor and memory are further configured to receive and process the sensed force information to estimate force applied to the chest during the chest compressions, and adjust a magnitude of the scheduled depths to patient-specific depths for one or more remaining chest compressions of the plurality of chest compressions of the initial compression protocol based on the estimated force applied to the chest during one or more preceding chest compressions of the plurality of chest compressions.

According to another aspect of the disclosure, a system for administering chest compressions to a patient includes an automated chest compressor configured to be applied to a chest of the patient to administer chest compressions to the patient. The chest compressor includes a compression surface configured to be positioned on the patient's chest, a driver configured to move the compression surface in a first direction to compress the patient's chest and in a second direction to release the patient's chest, and at least one displacement sensor configured to measure distance traveled by the patient's chest and/or the compression surface to estimate a depth and/or decompression height of the chest compression. The chest compressor further comprises at least one processor and memory communicatively coupled with the chest compressor and the at least one displacement sensor. The at least one processor and memory are configured to cause the chest compressor to: repeatedly cause the driver of the chest compressor to move the compression surface in the first direction until a signal received by the at least one processor from the at least one displacement sensor indicates that the compression surface has moved a sufficient distance to perform a chest compression of a temporary target depth, and, once the temporary target depth is reached, causing the driver to move the compression surface in the second direction to a temporary decompression height identified based on the signal from the at least one displacement sensor. The processor and memory are further configured to: following one or more of the compressions, adjust the target compression depth and/or target decompression height according to a predetermined initial compression protocol including a predetermined number of chest compressions; after completion of the predetermined number of chest compressions of the initial compression protocol, cause the driver of the chest compressor to repeatedly move the compression surface in the first direction until the signal received by the at least one processor from the at least one displacement sensor indicates that the compression surface has moved a sufficient distance to perform a chest compression of a predetermined final target depth; and cause the driver to move the compression surface in the second direction to a predetermined final decompression height identified based on the signal from the at least one displacement sensor.

According to another aspect of the disclosure, a system for assisting an acute care provider in performance of chest compressions to a patient includes: at least one chest compression sensor configured to sense displacement information in response to chest compressions administered by the acute care provider; a feedback device for providing guidance for the acute care provider in the performance of the chest compressions; and at least one processor and memory communicatively coupled with the at least one chest compression sensor and the feedback device. The at least one processor and memory can be configured to: receive and process the sensed displacement information from the at least one chest compression sensor during the performance of the chest compressions; estimate compression depth based on the processed displacement information; and cause the feedback device to provide guidance for the acute care provider for administration of the chest compressions of scheduled depths over an initial compression period according to an initial compression protocol. The initial compression protocol includes a plurality of chest compressions of increasing scheduled depths with a first compression at an initial depth and a final compression at a final target depth greater in magnitude than the initial depth.

According to another aspect of the disclosure, a system for assisting an acute care provider in performance of chest compressions to a patient includes: at least one motion sensor configured to be positioned on the patient's chest to sense displacement information for the chest in response to chest compressions administered by the acute care provider; at least one force sensor configured to sense force information from the applied chest compressions; a feedback device for providing guidance for the acute care provider in the performance of the chest compressions; and at least one processor and memory communicatively coupled with the at least one motion sensor, the at least one force sensor, and the feedback device. The at least one processor and memory are configured to: receive and process the sensed displacement information from the at least one motion sensor during the performance of the chest compressions to estimate compression depth for the chest compressions; receive and process the sensed force information produced from the at least one force sensor during the performance of the chest compressions to estimate force applied to the chest for the chest compressions; and cause the feedback device to provide guidance for the acute care provider for administration of the chest compressions of scheduled depths over an initial compression period according to an initial compression protocol. The initial compression protocol includes a plurality of chest compressions of increasing scheduled depths with a first compression at an initial depth and a final compression at a final target depth greater in magnitude than the initial depth. The processor and memory are further configured to periodically adjust a magnitude of the scheduled depths to patient-specific depths for one or more remaining chest compressions of the plurality of chest compressions of the initial compression protocol based on the estimated force applied to the chest during one or more preceding chest compressions of the plurality of chest compressions.

Examples of the present disclosure will now be described in the following numbered clauses:

Clause 1: A system for administering patient-specific chest compressions to a patient, the system comprising: an automated chest compressor configured to be applied to the chest of the patient to administer chest compressions to the patient; at least one force sensor configured to sense force information for force exerted on the patient by the chest compressor from the applied chest compressions; and at least one processor and memory communicatively coupled with the chest compressor and the at least one force sensor, wherein the at least one processor and memory are configured to: control the chest compressor to administer the chest compressions over an initial compression period according to an initial compression protocol, the initial compression protocol comprising a plurality of chest compressions of increasing scheduled depths with a first compression at an initial depth and a final compression at a final target depth greater in magnitude than the initial depth, receive and process the sensed force information to estimate force applied to the chest during the chest compressions, and adjust a magnitude of the scheduled depths to patient-specific depths for one or more remaining chest compressions of the plurality of chest compressions of the initial compression protocol based on the estimated force applied to the chest during one or more preceding chest compressions of the plurality of chest compressions.

Clause 2: The system of clause 1, wherein the initial compression protocol comprises at least a first portion of the plurality of chest compressions in which the scheduled depth of the chest compressions increases at a first rate.

Clause 3: The system of clause 2, wherein the initial compression protocol comprises at least a second portion of the plurality of chest compressions in which the scheduled depths of the chest compressions increase at a second rate, the second rate being different from the first rate.

Clause 4: The system of clause 3, wherein the second rate is greater than the first rate.

Clause 5: The system of any of clauses 1-4, wherein the adjustment of the magnitude of the scheduled depths to the patient-specific depths for the one or more remaining chest compressions occurs at regular intervals.

Clause 6: The system of any of clauses 1-5, wherein the initial compression protocol comprises a continuous linear increase in the scheduled depths over the initial compression period.

Clause 7: The system of any of clauses 1-5, wherein the adjustment in the magnitude of the scheduled depths to the patient-specific depths of the one or more remaining chest compressions comprises a decrease of the scheduled depths for at least one of the one or more remaining chest compressions.

Clause 8: The system of any of clauses 1-7, wherein the adjustment of the magnitude of the scheduled depths to the patient-specific depths for the one or more remaining chest compressions is further based, at least in part, on a number of the preceding chest compressions already provided to the patient.

Clause 9: The system of any of clauses 1-8, wherein the at least one processor and memory are further configured to control the chest compressor to repeatedly administer chest compressions at the final target depth, once the adjusted patient-specific depths reaches the final target depth or following the plurality of chest compressions of the initial compression protocol.

Clause 10: The system of any of clauses 1-9, wherein the initial compression period comprises a period of time of about 30 seconds to about 5 minutes.

Clause 11: The system of any of clauses 1-9, wherein the initial compression period comprises a period of time of about 1 minute to about 2 minutes.

Clause 12: The system of any of clauses 1-11, wherein the adjustment in the magnitude of the scheduled depths to the patient-specific depths is based on whether the estimated force falls outside of an expected range.

Clause 13: The system of clause 12, wherein determination of whether the estimated force falls outside of the expected range comprises determination of whether the estimated force exceeds a predetermined force threshold.

Clause 14: The system of any of clauses 1-13, wherein the at least one processor and memory are further configured to control the chest compressor to administer the chest compressions according to one or more additional patient-specific compression parameters over the initial compression period.

Clause 15: The system of clause 14, wherein the one or more patient-specific compression parameters comprise at least one of: compression force, compression hold time, release velocity, downstroke acceleration, downstroke velocity, lift displacement, lift force, upstroke acceleration, and upstroke velocity.

Clause 16: The system of any of clauses 1-15, further comprising at least one displacement sensor configured to sense displacement signals corresponding to displacement of the patient's chest during the applied chest compressions, wherein the at least one processor and memory are configured to receive and process the displacement signals to estimate displacement of the chest during the chest compressions.

Clause 17: The system of clause 16, wherein the adjustment of the magnitude of the scheduled depths to the patient-specific depths for one or more remaining chest compressions of the plurality of chest compressions is based, at least in part, on the estimated displacement.

Clause 18: The system of clause 16, wherein the adjustment in the magnitude of the scheduled depths to the patient-specific depths for the one or more remaining chest compressions of the plurality of chest compressions is based, at least in part, on estimated chest compliance over the one or more preceding chest compressions.

Clause 19: The system of clause 18, wherein the estimated chest compliance is based on the estimated force and the estimated displacement.

Clause 20: The system of any of clauses 1-19, wherein the adjustment in the magnitude of the scheduled depths to the patient-specific depths for the one or more remaining chest compressions of the plurality of chest compressions comprises a non-linear increase in compression depths for the one or more remaining chest compressions based on an increase or decrease in an estimated chest compliance over the one or more preceding chest compressions.

Clause 21: The system of any of clauses 1-19, wherein the adjustment in the magnitude of the scheduled depths to the patient-specific depths for the one or more remaining chest compressions of the plurality of chest compressions comprises a substantially linear increase in compression depths for the one or more remaining chest compressions.

Clause 22: The system of any of clauses 1-21, wherein the initial depth comprises a depth of about 0.1 inch to about 1.0 inch.

Clause 23: The system of any of clauses 1-22, wherein the target final depth comprises a depth of about 2.0 inches to about 2.4 inches.

Clause 24: The system of any of clauses 1-23, wherein the initial compression protocol comprises a first portion comprising chest compressions of the initial depth, a second portion comprising chest compressions of at least one intermediate depth between the initial depth and the final target depth, and a third portion comprising chest compressions at the final target depth.

Clause 25: The system of clause 24, wherein the at least one intermediate depth comprises a depth of about 0.5 inch to about 2.0 inches.

Clause 26: The system of any of clauses 1-25, wherein the chest compressor is configured to provide active compression/decompression treatment to the chest of the patient.

Clause 27: The system of any of clauses 1-25, wherein the chest compressor comprises a compression belt and a belt tensioner configured to tighten the compression belt around the chest of the patient in order to compress the chest of the patient.

Clause 28: The system of any of clauses 1-25, wherein the chest compressor is a piston-based system that comprises: a piston, a piston driver, support structures for supporting the piston and the piston driver, and a compression pad affixed to the piston.

Clause 29: A system for administering chest compressions to a patient, the system comprising: an automated chest compressor configured to be applied to a chest of the patient to administer chest compressions to the patient, the chest compressor comprising a compression surface configured to be positioned on the patient's chest, a driver configured to move the compression surface in a first direction to compress the patient's chest and in a second direction to release the patient's chest, and at least one displacement sensor configured to measure distance traveled by the patient's chest and/or the compression surface to estimate a depth and/or decompression height of the chest compression; and at least one processor and memory communicatively coupled with the chest compressor and the at least one displacement sensor, wherein the at least one processor and memory are configured to cause the chest compressor to: repeatedly cause the driver of the chest compressor to move the compression surface in the first direction until a signal received by the at least one processor from the at least one displacement sensor indicates that the compression surface has moved a sufficient distance to perform a chest compression of a temporary target depth, and once the temporary target depth is reached, causing the driver to move the compression surface in the second direction to a temporary decompression height identified based on the signal from the at least one displacement sensor, following one or more of the compressions, adjust the target compression depth and/or target decompression height according to a predetermined initial compression protocol comprising a predetermined number of chest compressions, and after completion of the predetermined number of chest compressions of the initial compression protocol, cause the driver of the chest compressor to repeatedly move the compression surface in the first direction until the signal received by the at least one processor from the at least one displacement sensor indicates that the compression surface has moved a sufficient distance to perform a chest compression of a predetermined final target depth and cause the driver to move the compression surface in the second direction to a predetermined final decompression height identified based on the signal from the at least one displacement sensor.

Clause 30: The system of clause 29, wherein the initial compression protocol comprises at least one portion in which the temporary target depth increases at a constant rate per compression.

Clause 31: The system of clause 30, wherein the initial compression protocol comprises at least a first portion in which the temporary target depth increases at a first rate per compression and at least a second portion in which the temporary target chest compression depth increases at a second rate per compression, the second rate being different from the first rate.

Clause 32: The system of clause 31, wherein the second rate is greater than the first rate.

Clause 33: The system of any of clauses 29-32, wherein the adjustment of the temporary target compression depth according to the initial compression protocol comprises a continuous linear increase in compression depth over the predetermined number of the chest compressions.

Clause 34: The system of any of clauses 29-32, wherein the adjustment in the temporary target compression depth according to the initial compression protocol comprises a decrease in compression depth over at least a portion of the predetermined number of the chest compressions.

Clause 35: The system of any of clauses 29-34, wherein the predetermined number of chest compressions lasts between about 30 seconds and about 5 minutes.

Clause 36: The system of any of clauses 29-34, wherein the predetermined number of chest compressions lasts between about 1 minute and about 2 minutes.

Clause 37: The system of any of clauses 29-36, wherein the at least one processor and memory are configured to control the chest compressor to administer the chest compressions according to one or more additional patient-specific compression parameters over the initial compression protocol.

Clause 38: The system of clause 37, wherein the one or more patient-specific compression parameters comprises at least one of: compression force, compression hold time, release velocity, downstroke acceleration, downstroke velocity, lift displacement, lift force, upstroke acceleration, and upstroke velocity.

Clause 39. The system of any of clauses 29-36, wherein the adjustment of the temporary target compression depth comprises a substantially linear increase in the temporary target compression depth over the predetermined number of chest compressions.

Clause 40: The system of any of clauses 29-39, wherein the temporary target compression depth for a first chest compression of the initial compression protocol is about 0.1 inch to about 1.0 inch.

Clause 41: The system of any of clauses 29-40, wherein the final target compression depth is about 2.0 inch to about 2.4 inch.

Clause 42: The system of any of clauses 29-36, wherein the adjustment of the temporary target compression depth according to the initial compression protocol comprises a first portion of one or more chest compressions of a first temporary target depth, a second portion of one or more chest compressions of at least one intermediate temporary target compression depth, and a third portion of one or more chest compressions of a third temporary target compression depth.

Clause 43: The system of clause 42, wherein the at least one intermediate compression depth comprises a depth of about 0.5 inch to about 2.0 inches.

Clause 44: The system of any of clauses 29-43, wherein the temporary target decompression height for at least one of the chest compressions is a vertical distance above a neutral position of the patient's chest, thereby providing active chest decompression.

Clause 45: The system of any of clauses 29-44, wherein the compression surface comprises a compression belt and the driver comprises a belt tensioner configured to tighten the compression belt around the chest of the patient in order to compress the chest of the patient.

Clause 46: The system of any of clauses 29-44, wherein the chest compressor is a piston-based system, in which the driver comprises a piston and a piston driver, and the compression surface comprises a compression pad affixed to the piston, the system further comprising support structures for supporting the piston and piston driver.

Clause 47: A system for assisting an acute care provider in performance of chest compressions to a patient, the system comprising: at least one chest compression sensor configured to sense displacement information in response to chest compressions administered by the acute care provider; a feedback device for providing guidance for the acute care provider in the performance of the chest compressions; and at least one processor and memory communicatively coupled with the at least one chest compression sensor and the feedback device, wherein the at least one processor and memory are configured to: receive and process the sensed displacement information from the at least one chest compression sensor during the performance of the chest compressions, estimate compression depth based on the processed displacement information, and cause the feedback device to provide guidance for the acute care provider for administration of the chest compressions of scheduled depths over an initial compression period according to an initial compression protocol, the initial compression protocol comprising a plurality of chest compressions of increasing scheduled depths with a first compression at an initial depth and a final compression at a final target depth greater in magnitude than the initial depth.

Clause 48: The system of clause 47, wherein the at least one chest compression sensor comprises at least one of: an accelerometer, a displacement sensor, a velocity sensor, and a force sensor.

Clause 49: The system of clause 47 or clause 48, wherein the guidance provided by the feedback device comprises at least one of: visual feedback, audible feedback, and haptic feedback.

Clause 50: The system of any of clauses 47-49, wherein the feedback device is configured to provide an indication of whether the estimated depth for a particular chest compression of the plurality of chest compressions falls outside of a range of the scheduled depth for the particular chest compression of the plurality of chest compressions.

Clause 51: The system of any of clauses 47-50, wherein the initial compression protocol comprises at least a first portion of the plurality of chest compressions in which the scheduled depth of the chest compressions increases at a first rate per compression.

Clause 52: The system of clause 51, wherein the initial compression protocol comprises at least a second portion of the plurality of chest compressions in which the scheduled depth of the chest compressions increases at a second rate, the second rate being different from the first rate.

Clause 53: The system of clause 52, wherein the second rate is greater than the first rate.

Clause 54: The system of any of clauses 47-53, wherein the initial compression protocol comprises a first portion comprising chest compressions of the initial depth, a second portion comprising chest compressions of at least one intermediate depth between the initial depth and the final target depth, and a third portion comprising chest compressions at the final target depth.

Clause 55: The system of clause 54, wherein the at least one intermediate depth comprises a depth of about 0.5 inch to about 2.0 inches.

Clause 56: The system of any of clauses 47-55, wherein the initial compression protocol comprises a continuous linear increase in the scheduled depths over the initial compression period.

Clause 57: The system of any of clauses 47-56, wherein the initial depth comprises a depth of about 0.1 inch to 1.0 inch.

Clause 58: The system of any of clauses 47-57, wherein the final target depth comprises a depth of about 2.0 inches to about 2.4 inches.

Clause 59: The system of any of clauses 47-58, wherein the initial compression period comprises a period of time of about 30 seconds to 5 minutes.

Clause 60: The system of any of clauses 47-58, wherein the initial compression period comprises a period of time of about 1 minute to about 2 minutes.

Clause 61: The system of any of clauses 47-60, wherein the at least one chest compression sensor comprises at least one motion sensor configured to sense the displacement information, the system further comprising at least one force sensor configured to sense force information from the applied chest compressions, wherein the at least one processor and memory are configured to receive and process the sensed force information produced from the at least one force sensor to estimate force applied to the chest.

Clause 62: The system of clause 61, wherein the at least one processor and memory are configured to adjust a magnitude of the scheduled depths to patient-specific depths for one or more remaining chest compressions of the plurality of chest compressions of the initial compression protocol based on the estimated force applied to the chest during one or more preceding chest compressions of the plurality of chest compressions so that guidance provided by the feedback device is for administration of chest compressions at the adjusted patient-specific depths for the one or more remaining chest compressions of the initial compression protocol.

Clause 63: The system of clause 62, wherein the adjustment of the magnitude of the scheduled depths to the patient-specific depths for the one or more remaining chest compressions occurs at regular intervals.

Clause 64: The system of clause 62, wherein the adjustment in the magnitude of the scheduled depths to the patient-specific depths is based on whether the estimated force falls outside of an expected range.

Clause 65: The system of clause 64, wherein determination of whether the estimated force falls outside of the expected range comprises determination of whether the estimated force exceeds a predetermined force threshold.

Clause 66: The system of clause 62, wherein the adjustment in the magnitude of the scheduled depths to the patient-specific depths for the one or more remaining chest compressions of the plurality of chest compressions is based, at least in part, on estimated chest compliance over the one or more preceding chest compressions.

Clause 67: The system of clause 66, wherein the estimated chest compliance is based on the estimated force and the estimated displacement.

Clause 68: The system of clause 62, wherein the adjustment in the magnitude of the scheduled depths to the patient-specific depths for the one or more remaining chest compressions of the plurality of chest compressions comprises a non-linear increase in compression depths for the one or more remaining chest compressions based on an increase or decrease in an estimated chest compliance over the one or more preceding chest compressions.

Clause 69: The system of clause 62, wherein the adjustment in the magnitude of the scheduled depths to the patient-specific depths of the one or more remaining chest compressions comprises a decrease of the scheduled depths to the patient-specific depths for at least one of the one or more remaining chest compressions.

Clause 70: The system of clause 62, wherein the adjustment of the magnitude of the scheduled depths to the patient-specific depths for one or more remaining chest compressions of the plurality of chest compressions of the initial compression protocol is further based, at least in part, on a number of the preceding chest compressions already provided to the patient.

Clause 71: The system of clause 62, wherein the at least one processor and memory are configured to cause the feedback device to repeatedly provide guidance for the acute care provider for administration of the chest compressions at the final target depth, once the adjusted patient-specific depth reaches the final target depth, or following the plurality of chest compressions of the initial compression protocol.

Clause 72: The system of any of clauses 47-71, wherein the at least one processor and memory are configured to control the feedback device to provide guidance for the acute care provider for the administration of the chest compressions according to one or more additional compression parameters over the initial compression period.

Clause 73: The system of clause 72, wherein the one or more additional compression parameters comprise at least one of: compression hold time, release velocity, downstroke acceleration, downstroke velocity, lift displacement, lift force, upstroke acceleration, and upstroke velocity.

Clause 74: The system of any of clauses 71-73, wherein the feedback device comprises a visual display that displays a user interface for providing the guidance for the acute care provider for the administration of the chest compressions.

Clause 75: The system of clause 74, wherein the user interface comprises a visual indicator for actual compression depth and at least one dynamic target indicator showing the scheduled depth for a particular chest compression of the plurality of chest compressions.

Clause 76: The system of clause 75, wherein the at least one dynamic target indicator comprises a first indicator showing a minimal acceptable depth related to the scheduled depth and a second indicator showing a maximum acceptable depth related to the scheduled depth.

Clause 77: The system of clause 75 or clause 76, wherein the at least one processor and memory are configured to adjust a position of the at least one dynamic target indicator on the user interface according to the initial compression protocol to guide the acute care provider in administration of a next chest compression of the plurality of chest compressions.

Clause 78: The system of any of clauses 47-77, further comprising an active compression decompression device configured to be used by the acute care provider for administration of active compression/decompression treatment to the patient.

Clause 79: A system for assisting an acute care provider in performance of chest compressions to a patient, the system comprising: at least one motion sensor configured to be positioned on the patient's chest to sense displacement information for the chest in response to chest compressions administered by the acute care provider; at least one force sensor configured to sense force information from the applied chest compressions; a feedback device for providing guidance for the acute care provider in the performance of the chest compressions; and at least one processor and memory communicatively coupled with the at least one motion sensor, the at least one force sensor, and the feedback device, wherein the at least one processor and memory are configured to: receive and process the sensed displacement information from the at least one motion sensor during the performance of the chest compressions to estimate compression depth for the chest compressions, receive and process the sensed force information produced from the at least one force sensor during the performance of the chest compressions to estimate force applied to the chest for the chest compressions, cause the feedback device to provide guidance for the acute care provider for administration of the chest compressions of scheduled depths over an initial compression period according to an initial compression protocol, the initial compression protocol comprising a plurality of chest compressions of increasing scheduled depths with a first compression at an initial depth and a final compression at a final target depth greater in magnitude than the initial depth, and periodically adjust a magnitude of the scheduled depths to patient-specific depths for one or more remaining chest compressions of the plurality of chest compressions of the initial compression protocol based on the estimated force applied to the chest during one or more preceding chest compressions of the plurality of chest compressions.

Clause 80: The system of clause 79, wherein the at least one motion sensor comprises at least one of: an accelerometer, a displacement sensor, and a velocity sensor.

Clause 81: The system of clause 79 or clause 80, wherein the at least one force sensor comprises a strain gauge.

Clause 82: The system of any of clauses 79-81, wherein the guidance provided by the feedback device comprises at least one of: visual feedback, audible feedback, and haptic feedback.

Clause 83: The system of any of clauses 79-82, wherein the feedback device is configured to provide an indication of whether the estimated depth for a particular chest compression of the plurality of chest compressions falls outside of a range of the patient-specific depth for the particular chest compression of the plurality of chest compressions.

Clause 84: The system of any of clauses 79-83, wherein the initial compression protocol comprises at least a first portion of the plurality of chest compressions in which the scheduled depths of the chest compressions increases at a first rate per compression.

Clause 85: The system of clause 84, wherein the initial compression protocol comprises at least a second portion of the plurality of chest compressions in which the scheduled depths of the chest compressions increases at a second rate, the second rate being different from the first rate.

Clause 86: The system of clause 85, wherein the second rate is greater than the first rate.

Clause 87: The system of any of clauses 79-86, wherein the initial compression protocol comprises a first portion comprising chest compressions of the initial depth, a second portion comprising chest compressions of at least one intermediate depth between the initial depth and the final target depth, and a third portion comprising chest compressions of the final target depth.

Clause 88: The system of clause 87, wherein the at least one intermediate depth comprises a depth of about 0.5 inch to about 2.0 inches.

Clause 89: The system of any of clauses 79-88, wherein the initial compression protocol comprises a continuous linear increase in the scheduled depths over the initial compression period.

Clause 90: The system of any of clauses 79-89, wherein the initial depth comprises a depth of about 0.1 inch to 1.0 inch.

Clause 91: The system of any of clauses 79-89, wherein the final target depth comprises a depth of about 2.0 inches to about 2.4 inches.

Clause 92: The system of any of clauses 79-91, wherein the initial compression period comprises a period of time between about 30 seconds and about 5 minutes.

Clause 93: The system of clause 79, wherein the initial compression period comprises a period of time of about 1 minute to about 2 minutes.

Clause 94: The system of any of clauses 79-93, wherein the periodic adjustment of the magnitude of the scheduled depths to the patient-specific depths for the one or more remaining chest compressions occurs at regular intervals.

Clause 95: The system of any of clauses 79-93, wherein the periodic adjustment in the magnitude of the scheduled depths to the patient-specific depths is based on whether the estimated force falls outside of an expected range.

Clause 96: The system of clause 95, wherein determination of whether the estimated force falls outside of the expected range comprises determination of whether the estimated force exceeds a predetermined force threshold.

Clause 97: The system of any of clauses 79-96, wherein the periodic adjustment in the magnitude of the scheduled depths to the patient-specific depths for the one or more remaining chest compressions of the plurality of chest compressions is based, at least in part, on estimated chest compliance over the one or more preceding chest compressions.

Clause 98: The system of clause 97, wherein the estimated chest compliance is based on the estimated force and the estimated displacement.

Clause 99: The system of any of clauses 79-98, wherein the periodic adjustment in the magnitude of the scheduled depths to the patient-specific depths for the one or more remaining chest compressions of the plurality of chest compressions comprises a non-linear increase in compression depths for the one or more remaining chest compressions based on an increase or decrease in an estimated chest compliance over the one or more preceding chest compressions.

Clause 100: The system of any of clauses 79-99, wherein the periodic adjustment in the magnitude of the scheduled depths to the patient-specific depths of the one or more remaining chest compressions comprises a decrease of the scheduled depths to the patient-specific depths for at least one of the one or more remaining chest compressions.

Clause 101: The system of any of clauses 79-100, wherein the periodic adjustment of the magnitude of the scheduled depths to the patient-specific depths for the one or more remaining chest compressions of the plurality of chest compressions of the initial compression protocol is further based, at least in part, on a number of the preceding chest compressions already provided to the patient.

Clause 102: The system of any of clauses 79-101, wherein the at least one processor and memory are configured to cause the feedback device to repeatedly provide guidance for the acute care provider for administration of the chest compressions at the final target depth, once the adjusted patient-specific depth reaches the final target depth, or following the plurality of compressions of the initial compression protocol.

Clause 103: The system of any of clauses 79-102, wherein the at least one processor and memory are configured to control the feedback device to provide guidance for the acute care provider for the administration of the chest compressions according to one or more additional compression parameters over the initial compression period.

Clause 104: The system of clause 103, wherein the one or more additional compression parameters comprise at least one of: compression hold time, release velocity, downstroke acceleration, downstroke velocity, lift displacement, lift force, upstroke acceleration, and upstroke velocity.

Clause 105: The system of any of clauses 79-104, wherein the feedback device comprises a visual display that displays a user interface for providing the guidance for the acute care provider for the administration of the chest compressions.

Clause 106: The system of clause 105, wherein the user interface comprises a visual indicator for actual compression depth and at least one dynamic target indicator showing the patient-specific depth for a particular chest compression of the plurality of chest compressions.

Clause 107: The system of clause 106, wherein the at least one dynamic target indicator comprises a first indicator showing a minimal acceptable depth related to the patient-specific depth and a second indicator showing a maximum acceptable depth related to the patient-specific depth.

Clause 108: The system of clause 106 or clause 107, wherein the at least one processor and memory are configured to adjust a position of the at least one dynamic target indicator on the user interface according to the initial compression protocol to guide the acute care provider in administration of a subsequent chest compression of the plurality of chest compressions.

Clause 109: The system of any of clauses 79-108, further comprising an active compression decompression device configured to be used by the acute care provider for administration of active compression/decompression treatment to the patient.

### BRIEF DESCRIPTION OF THE DRAWINGS

Various aspects of the disclosure are discussed below with reference to the accompanying figures, which are not intended to be drawn to scale. The figures are included to provide an illustration and a further understanding of various examples, and are incorporated in and constitute a part of this specification, but are not intended to limit the scope of the disclosure. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure. A quantity of each component in a particular figure is an example only and other quantities of each, or any, component could be used.

FIG. 1A is a schematic drawing of an example of a system for assisting an acute care provider in providing chest compressions to a patient;

FIG. 1B is a schematic drawing of electrical and computer components of the system for assisting the acute care provider in performing chest compressions of FIG. 1A;

FIGS. 2A-2C are graphs illustrating non-limiting examples of initial compression protocols for chest compressions that may be applied to a patient's chest during an initial compression period;

FIGS. 3A and 3B are schematic drawings of a medical device comprising a display that provides chest compression feedback to an acute care provider;

FIGS. 3C-3E are schematic drawings of additional examples of interface displays for a medical device that provides chest compression feedback;

FIG. 4 is a schematic drawing of an example of an active compression-decompression (ACD) device comprising a hand-held plunger for providing mechanically-assisted, active compression-decompression to a patient;

FIGS. 5A-5D are graphs showing additional examples of initial compression protocols that may be applied to the patient's chest during the initial compression period including both compression and decompression portions;

FIGS. 6A and 6B are schematic drawings of the ACD device of FIG. 4 comprising a display on a handle of the ACD device that provides feedback for active chest compressions and decompressions;

FIG. 7 is a flowchart of an example process for implementing an initial compression protocol that can be adjusted in response to measured parameter(s) for use in conjunction with manual and/or mechanically-assisted active compression-decompression;

FIG. 8A is a schematic drawing of an example of an automated chest compression system comprising a belt-based automated chest compressor for providing automated chest compressions to a patient;

FIG. 8B is a schematic drawing of an example of an automated chest compression system comprising a piston-based automated chest compressor for providing automated chest compressions to a patient;

FIG. 8C is a schematic drawing of computer and electrical components of the systems of FIGS. 8A and 8B;

FIGS. 9A-9E are graphs showing examples of initial compression protocols including portions adjusted in response to measured parameter(s) to provide chest compressions at patient-specific depths;

FIG. 10 is a flowchart of an example process for implementing an initial compression protocol that can be adjusted in response to measured parameter(s) for use in conjunction with an automated chest compressor;

FIGS. 11A-11D are graphs showing experimental results for chest compressions applied to a patient over multiple compression cycles according to an initial compression protocol performed over an initial compression period;

FIG. 12 is a line graph showing force-displacement loops for the multiple compression cycles provided to the patient of FIGS. 11A-11D; and

FIG. 13 is a line graph of experimental results showing force-displacement loops for multiple compression cycles applied to a patient according to the initial compression protocol over the initial compression period.

### DESCRIPTION OF THE INVENTION

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limit of the disclosure.

As used herein, the singular form of “a”, “an”, and “the” include plural referents unless the context clearly dictates otherwise.

As used herein, the terms “right”, “left”, “top”, and derivatives thereof shall relate to aspects of the present disclosure as it is oriented in the drawing figures. However, it is to be understood that embodiments of the present disclosure can assume various alternative orientations and, accordingly, such terms are not to be considered as limiting. Also, it is to be understood that embodiments of the present disclosure can assume various alternative variations and stage sequences, except where expressly specified to the contrary. It is also to be understood that the specific devices and processes illustrated in the attached drawings, and described in the following specification, are provided as examples. Hence, specific dimensions and other physical characteristics related to the embodiments disclosed herein are not to be considered as limiting.

As used herein, including in the claims, “and” as used in a list of items prefaced by “at least one of” indicates a disjunctive list such that, for example, a list of “at least one of A, B, and C” means A or B or C or AB or AC or BC or ABC (i.e., A and B and C), or combinations with more than one feature (e.g., AA, AAB, ABBC, etc.). As used herein, including in the claims, unless otherwise stated, a statement that a function or operation is “based on” an item or condition means that the function or operation is based on the stated item or condition and may be based on one or more items and/or conditions in addition to the stated item or condition.

As used herein, the terms “communication” and “communicate” refer to the receipt or transfer of one or more signals, messages, commands, or other type of data. For one unit or component to be in communication with another unit or component means that the one unit or component is able to directly or indirectly receive data from and/or transmit data to the other unit or component. This can refer to a direct or indirect connection that can be wired and/or wireless in nature. Additionally, two units or components can be in communication with each other even though the data transmitted can be modified, processed, routed, and the like, between the first and second unit or component. For example, a first unit can be in communication with a second unit even though the first unit passively receives data, and does not actively transmit data to the second unit. As another example, a first unit can be in communication with a second unit if an intermediary unit processes data from one unit and transmits processed data to the second unit. It will be appreciated that numerous other arrangements are possible.

Systems and methods for assisting rescuers, such as acute care providers or lay persons, to treat patients during medical emergencies, particularly cardiac arrest, are disclosed herein. Medical emergencies require a rapid response to increase the likelihood of achieving a positive outcome for the patient and to provide the best chance for patient survival. For victims of cardiac arrest, cardiopulmonary resuscitation (CPR) is an indicated form of treatment, which includes chest compressions for increasing circulation of blood to core and peripheral tissues. However, by their nature of providing substantial force to the thorax, chest compressions may cause accidental injuries to the patient. While fairly uncommon, these accidental injuries may be life-threatening. Common injuries related to chest compressions may include fractures of the ribs and/or sternum. Elderly patients and those with compromised skeletal systems may be especially susceptible to such injuries. Moreover, such injuries often reduce the effectiveness of the chest compressions as the injuries may affect how well or how much the patient's chest is able to return to its starting or initial position after a chest compression down stroke.

Accordingly, systems and methods are disclosed herein for providing an initial compression protocol (also referred to as a ramp up protocol) for an initial compression or ramp up period during CPR. During the initial compression protocol, the chest compressions are applied with gradually increasing scheduled depths until a final target depth is reached. For an adult patient, the final target depth can be about 2.0 inches to about 2.4 inches, as recommended by the 2015 American Heart Association Guidelines for chest compressions; however, it can be appreciated that other final target depths may be indicated or otherwise preferred. For example, the final target depth may be relatively greater for a larger person, or less for a smaller person. Once the final target depth is reached, chest compressions can be applied to the patient at the final target depth for an extended predetermined or indeterminate period of time, such as throughout the remainder of the time in which CPR is administered. For example, chest compressions at the final target depth may continue to be applied until other types of treatment, such as a defibrillation shock, can be applied to the patient.

In some examples, the initial compression protocol may be adjusted (e.g., in real time) to provide chest compressions at patient-specific depths for one or more remaining chest compressions of the initial compression protocol. As used herein, a “patient-specific depth” can refer to an adjusted target depth customized to the particular patient, determined based on measured parameters from preceding chest compressions having been provided to the patient, measured physiological parameters for the patient, and/or anatomical features of the patient. Adjusting target compression depths to the “patient-specific depth” during the initial compression or ramp up period allows a patient's chest to acclimate to chest compressions at its own “patient-specific” pace. For example, a patient's chest may require extra time to stretch out and physically adapt to receiving chest compressions, meaning that a magnitude of target depths and/or a rate of increase for target depths, for the initial compression protocol, may initially be less than that of the final target depth and may gradually increase so as to reach the final target depth once the patient's body has acclimated to the force caused by the chest compressions. Another patient's chest may be especially flexible and resilient, meaning that target compression depth can be increased, so that the final target depth can be achieved more quickly, without as much risk of injury. In general, the measured parameter(s) used for adjusting the initial compression protocol comprises measurements showing how the patient's chest is affected by the chest compressions. These measured parameter(s) provide information about whether increasing the chest compression depth would be more likely to cause damage or injury. For example, the target depths of the initial compression protocol may be adjusted based on input from force sensors configured to measure a force exerted on the patient's chest during chest compressions. Generally, force may be expected to decrease as chest compressions are performed, as the patient's chest is stretched and deformed by the compressions, becoming more accustomed to withstanding the repeated compression force.

As described in further detail herein, a medical device, such as a patient monitor, defibrillator, ventilator, or automated external defibrillator, may comprise and/or control a chest compression feedback device that guides an acute care provider in providing chest compressions according to selected chest compression parameters. The medical device can cause the feedback device to provide guidance according to an initial compression protocol and/or for chest compressions at patient-specific depths. Similarly, the medical device may also be in communication with and/or control an automated chest compressor to provide automated chest compressions to a patient according to the initial compression protocol and/or at the adjusted patient-specific depths. For example, if a force measurement (e.g., sensed measurements for force applied to the patient's chest during chest compressions) is above a predetermined threshold, there typically may be an increased chance of causing injury to the patient. In response to the force measurement exceeding the threshold, the medical device may control the feedback device or automated mechanical chest compressor to adjust a depth of future (e.g., remaining) chest compressions of the compression protocol from the scheduled target depth to a shallower (e.g., lower magnitude) patient-specific depth.

In many cases, the depth of the compressions would continue to increase throughout the initial compression protocol; however, the rate of increase may be reduced compared to the scheduled or predetermined target depths to account for the force measurements. Reducing a rate of increase of the target depth of the chest compressions may be expected to reduce the measured force values, thereby decreasing a likelihood of causing injuries to the patient during chest compressions.

Reducing the risk of injury during an initial compression period by employing a period of ramp up compressions is believed to be beneficial in the long term, for example, because the patient's chest is generally able to retain elasticity (i.e., ability to return to its original position). Retaining elasticity of the chest can improve effectiveness of future chest compressions, by allowing the heart to fill with a greater blood volume, compared to when the chest does not return to its original position following each compression. Retaining elasticity may also improve a velocity at which blood is expelled from the heart during compressions. Additionally, by preserving the natural elasticity, specifically of sternal cartilage, recoil velocity on compression upstroke may be better preserved, which may enhance negative intrathoracic pressure and, thereby, enhance diastolic filling of the heart. In addition to preserving natural elasticity, the initial compression period may also increase the range of vertical motion of the sternum, while preventing or minimizing nosocomial chest compression-related injury, thereby increasing the range of upward motion during active compression decompression (ACD) and enhancing diastolic filling and blood flow during chest compressions. There may be additional advantages to employing a ramp up period of chest compressions. For example, it may be beneficial to soften the myocardium and/or surrounding tissues to facilitate or otherwise enhance circulation. The ramp up period may also effectively serve to massage or increase muscular flexibility, which enables muscle and/or connective tissue to expand in a manner that more readily accepts blood during venous return and to compress in a manner that more readily expels blood during arterial contraction. Because the ramp up period reduces the risk of injury by preventing rib fractures, the ramp up period may further serve to protect the lungs from injury. For instance, broken ribs can lead to pneumothorax (i.e., collapsed lung) or lung contusion, and such injuries to the lungs could decrease the effectiveness of ventilation during CPR. Another potential injury that could be avoided is cardiac tamponade (i.e., fluid buildup around the heart). Cardiac tamponade may impair hemodynamics of circulation. Other organs, such as the spleen or liver, can also be lacerated with abrupt chest compression forces. Avoiding these injuries is of further benefit for the patient. Reducing injury can also make the recovery easier for patients that achieve sustained return of spontaneous circulation.

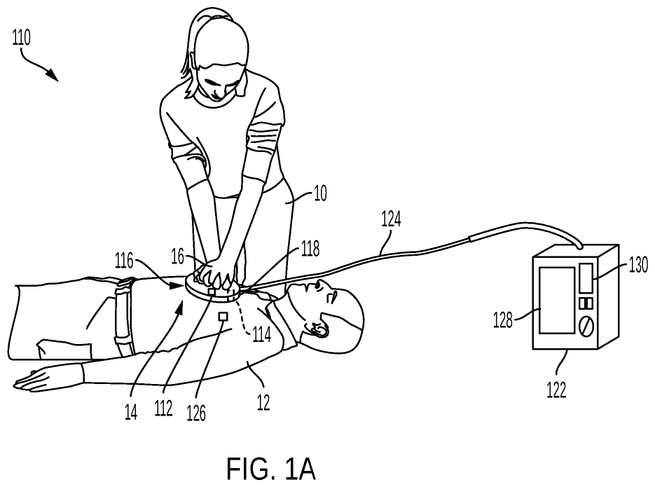

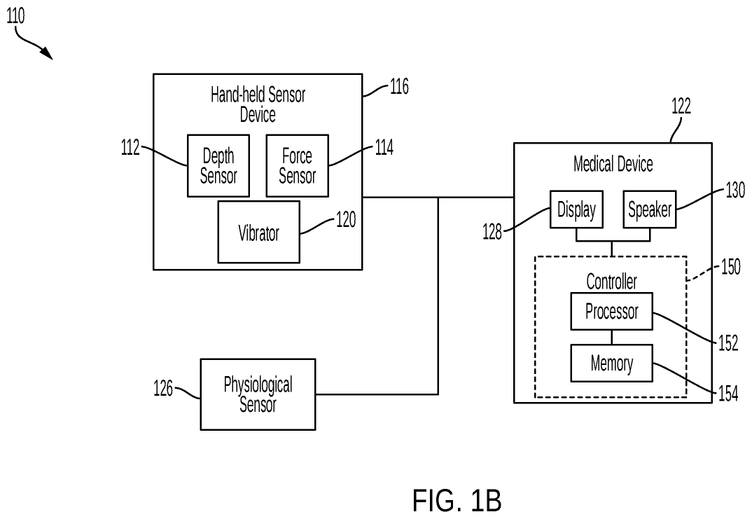

The systems and methods for providing the initial compression protocol and/or chest compressions at the patient-specific compression depths disclosed herein can be adapted for use with a variety of different types of chest compressions and/or chest compression devices, as are known in the art. Table 1 lists examples of different types of chest compressions and delivery systems that may be adapted for providing chest compressions according to an initial compression protocol and/or compressions at patient-specific depths. These various types of chest compressions are discussed in detail in connection with FIGS. 1A, 4, 8A, and 8B.

TABLE 1

| TYPE OF CHEST | |
|---|---|
| COMPRESSIONS | DELIVERY SYSTEM EXAMPLE |
| Standard chest compressions | Manual (e.g., hands of acute care |
| | provider) |
| ACD chest compressions | Manual (hand-held ACD device) |
| Automated chest compressions | Electromechanical belt-based system |
| Automated chest compressions | Electromechanical piston-based |
| | system |
| Automated ACD chest | Electromechanical piston-based or |
| compressions | belt-based ACD system |

Standard chest compressions refers to classic chest compressions by a caregiver's hands, for example, two-hand CPR (e.g., compressions according to Advanced Cardiac Life Support (ACLS) guidelines) or other techniques provided to pediatric patients such as two-finger CPR, where two fingers are used to compress the chest, or thumbs CPR, where an infant is held and compressed between the thumb positioned on the anterior side and the index fingers positioned on the posterior side. When the caregiver is manually providing compressions with his/her hands, the compression parameters are controlled by and subject to variability due to physical actions of the acute care provider or lay person. ACD chest compressions (e.g., delivered manually using an ACD device) refer to compressions delivered using devices that, though mechanical in nature, depend on the physical activity of the acute care provider to control the chest compressions. Automated chest compressions refer to chest compressions delivered by electromechanical devices (e.g., electromechanical belt-based system, electromechanical piston-based system, or electromechanical piston-based ACD system) that are controlled by computerized control systems, where compression parameters are predetermined by the programming and/or design of the device. The programming of the electromechanical devices often enables the parameters to be modified in real time. Beneficially, the electromechanical devices may not be subject to variability in compression depth or rate in the same way as standard chest compressions, which can be affected by a level of experience or fatigue of the individual performing the chest compressions.

### Standard or Manual Chest Compression Systems

With reference to FIGS. 1A and 1B, a system 110 for assisting an acute care provider 10 in performance of chest compressions to a patient 12 comprises a chest compression sensor configured to sense information about the chest compressions administered by the acute care provider 10 and a controller 150 (shown in FIG. 1B) in electronic communication with the chest compression sensor for processing and analyzing the sensed information. Although one acute care provider 10 is shown in FIG. 1A, more than one acute care provider may participate in resuscitation activities for the patient 12. The chest compression sensor can comprise a compression depth sensor 112 configured to sense information representative of compression depth. The depth sensor 112 can comprise a motion sensor, such as an accelerometer, a velocity sensor, or a displacement sensor. Alternatively or in addition, the chest compression sensor can comprise a force sensor 114 or force sensing system configured to sense information representative of force applied to the patient's chest during chest compressions. The force sensor 114 can be a strain gauge configured to convert a force, pressure, tension, or weight, into a measurable electrical resistance. In other examples, the force sensor 114 comprises a spring with a known spring constant. Alternatively, the force sensor 114 can comprise a pressure sensor, which measures an amount of applied pressure.

Force measurements can be analyzed to estimate compression rate or depth (in conjunction with a measurement of displacement or compliance). For example, when using force to estimate depth, the compliance or stiffness of the chest will affect how the chest deforms. Accordingly, when the compliance of the chest is known or can be estimated with reasonable accuracy, the depth can also be estimated from a force measurement. Also, force measurements can be used as input for a chest compression system (e.g., used for manual compressions and/or automated compressions) to adjust a target depth of remaining chest compressions of an initial compression protocol. Information and signals detected and output by the sensors 112, 114 may be represented using any of a variety of different technologies and techniques. For example, information or signals detected or output by the sensor(s) may be represented by voltages, currents, electromagnetic waves, magnetic fields, or any combination thereof, which may be processed in a manner that is useable to estimate physical measurements, such as force, displacement, compliance, etc.

The system 110 further comprises feedback device(s) in communication with the controller 150 for providing guidance for the acute care provider 10 in the performance of manual chest compressions. As used herein, “feedback” can refer to prompts, notifications, displays of chest compression information, and/or instructions, including haptic feedback, audible feedback, and/or visual feedback, which may be used to assist in guiding the acute care provider 10 in performance of the chest compressions according to certain criteria or parameters. Chest compression parameters can include, for example, compression force, compression rate (in compressions per minute), measured compression depth, and/or a decompression velocity (e.g., a release velocity). Chest compression parameters that can be measured or derived from information detected by the chest compression sensor(s) can also comprise compression hold time, downstroke acceleration, downstroke velocity, lift displacement, lift force, upstroke acceleration, and upstroke velocity.

Information and signals from the chest compression sensor(s) may be evaluated or analyzed to generate the feedback for the acute care provider 10. For example, the information from the chest compression sensor(s) may be used to determine, calculate, and/or estimate present values for the chest compression evaluation criteria or parameters. In that case, the feedback may provide an indication of the present values for such chest compression parameters. The feedback can also comprise information about target values for chest compression parameters and/or recommended changes to measured chest compression parameters or values relative to the target values. For example, the feedback may comprise indications to increase or decrease compression depth depending on whether the measured compression depth falls within a desired target range for compression depth, indications to compress at a faster or slower rate depending on whether the measured compression rate falls within a desired target range for compression rate, and/or indications to quickly and completely release the chest of the patient after each compression depending on whether the measured release velocity falls within a desired target range for release velocity. In general, feedback may be corrective feedback (i.e., feedback configured to cause an acute care provider 10 to change an aspect of the resuscitative care) and/or may be reported measurements (i.e., feedback that indicates a value or status of an aspect of the resuscitative care without a suggested change).

As shown in FIG. 1A, the system 110 further comprises a hand-held sensor device 116, often referred to as a CPR puck, resting on the chest 14 of the patient 12. The sensor device 116 comprises a housing 118 enclosing the sensors 112, 114 and associated electronic circuitry. The acute care provider 10 presses on the housing 118 with his or her hands 16 during performance of the chest compressions. The sensors 112, 114 measure the chest compression parameters as the chest compressions are being performed. Exemplary CPR assistance systems including CPR pucks positioned on the patient's chest for measuring information about and providing feedback for chest compressions performed for the patient are disclosed, for example, in U.S. Pat. No. 8,738,129 entitled “Real-time evaluation of CPR performance,” U.S. Pat. No. 9,387,147 entitled “System for assisting rescuers in performing cardio-pulmonary resuscitation (CPR) on a patient,” and U.S. Pat. No. 9,788,734 entitled “Defibrillator display,” each of which is incorporated by reference herein in its entirety.

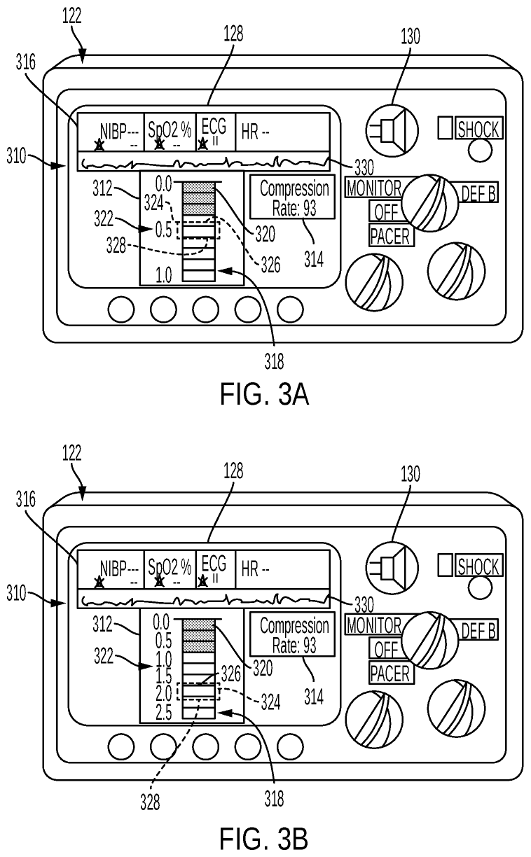

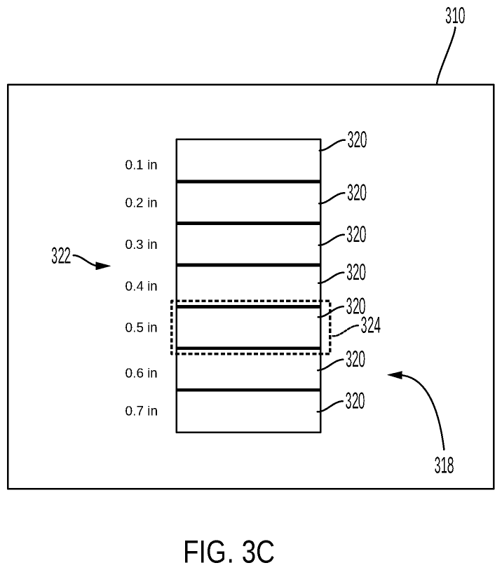

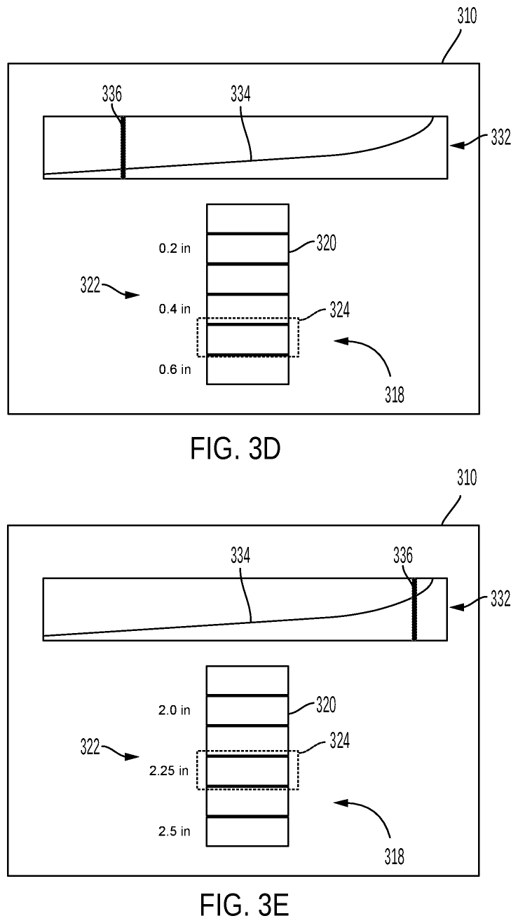

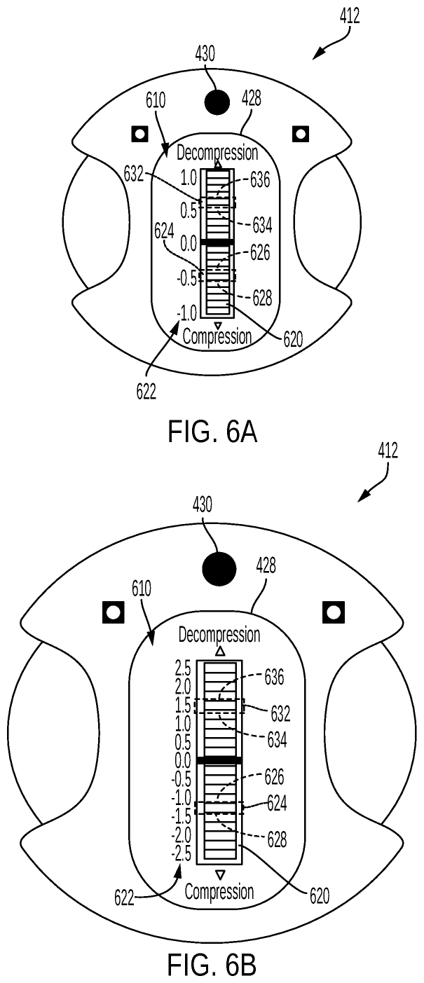

In some examples, the feedback device is positioned in the housing 118. For example, a haptic feedback device, such as a vibrator 120, may be positioned in the housing 118 and configured to cause the housing 118 to vibrate to provide feedback to the acute care provider 10. For example, the vibrator 120 may vibrate with a first haptic pattern to instruct the acute care provider 10 to begin a chest compression, and with a second haptic pattern when a target depth has been reached, indicating that the acute care provider 10 should release the compression. Alternatively or additionally, the system 110 may comprise separate feedback devices, such as a medical device 122 connected by wires 124 or wirelessly to the hand-held sensor device 116 and/or controller 150. In some examples, the controller 150 can be a computer processor of the medical device 122. The medical device 122 may comprise components for providing haptic, audible, and/or visual feedback to the acute care provider 10. For example, the medical device 122 may comprise a display 128 configured to display visual indicators and icons that provide information to the acute care provider 10 about how chest compressions should be performed. Examples of interfaces provided on displays of a medical device 122 are shown in FIGS. 3A-3E, 6A, and 6B. The medical device 122 may also comprise speakers 130 for providing audible notifications to the acute care provider 10. Also, the speakers 130 can provide compression feedback, such as a tones, beeps, or other sounds at a preferred rate (e.g., 100 tones per minute), and/or voice prompts (e.g., “begin with shallow compressions,” “push harder,” “compress deeper now,” or others), to provide an indication of the pace of chest compressions for the acute care provider 10.

The medical device 122 may be, for example, a patient monitor, a defibrillator, a mechanical chest compression device (e.g., an automated chest compression device, a belt-based chest compression device, a piston-based chest compression device, an active compression-decompression device, or combinations thereof), a ventilator, an intravenous cooling device, and/or combinations thereof. The ventilator may be a mechanical ventilator. The mechanical ventilator may be a portable, battery powered ventilator. The intravenous cooling device may deliver cooling therapy and/or may sense a patient's temperature. The medical device 122 may provide, for example, electrical therapy (e.g., defibrillation, cardiac pacing, synchronized cardioversion, diaphragmatic stimulation, and/or phrenic nerve stimulation), ventilation therapy, therapeutic cooling, temperature management therapy, invasive hemodynamic support therapy (e.g., extracorporeal membrane oxygenation (ECMO)), and/or combinations thereof. The medical device 122 may also be a wearable device (not shown), such as a smartwatch, worn by the acute care provider 10 for providing alarms, notifications, and feedback about the chest compressions.

In addition to the chest compression sensors (e.g., the depth sensor 112 and the force sensor 114), the system 110 may comprise additional sensors incorporated with and/or coupled (e.g., mechanically, electrically, and/or communicatively coupled) to the medical device 122. The additional sensors can be patient physiological sensors 126. The patient physiological sensors 126 may comprise, for example, cardiac sensing electrodes, ventilation sensor(s), and/or sensors capable of providing signals indicative of vital sign(s) of the patient 12, such as electrocardiogram (ECG), blood pressure (e.g., invasive blood pressure (IBP), non-invasive blood pressure (NIBP)), heart rate, pulse oxygen level, respiration rate, heart sounds, lung sounds, respiration sounds, end tidal CO₂, saturation of muscle oxygen (SMO₂), arterial oxygen saturation (SpO₂), cerebral blood flow, electroencephalogram (EEG) signals, brain oxygen level, tissue pH, tissue oxygenation, or tissue fluid levels. The physiological sensors 126 may also comprise sensors capable of providing signals indicative of parameters determined via ultrasound, video-laryngoscopy, airway or esophageal pressure sensors, near-infrared reflectance spectroscopy, pneumography, cardiography, ocular impedance, spirometry, tonometry, plethysmography, eye tracking, drug delivery parameters, fluid delivery parameters, transthoracic impedance, blood sampling, venous pressure monitoring (e.g., CVP), temperature, and/or non-invasive hemoglobin parameters. In some examples, the physiological sensors 126 may comprise electrodes or drug delivery devices that provide therapy to the patient 12.

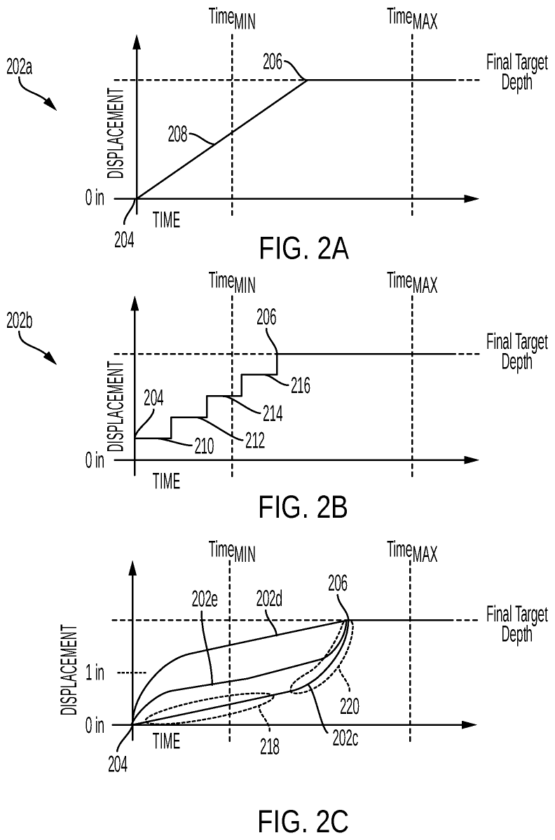

As shown in FIG. 1B, the controller 150 can comprise at least one processor 152 and memory 154 communicatively coupled with the depth sensor 112 and/or with the force sensor 114 and with the feedback device, such as the medical device 122, by wired and/or wireless connections. As described in detail herein, the processor 152 and memory 154 are configured to receive and process displacement information, such as signals detected by the depth sensor 112 and/or force sensor 114, representative of a compression depth for chest compressions performed by the acute care provider 10. The processor 152 and memory 154 are also configured to estimate compression depth based on the processed displacement information. For example, compression depth may be estimated by single integration of velocity measured by a velocity sensor or double-integration of acceleration signals detected by an accelerometer as described, for example, in U.S. Pat. No. 7,220,235, entitled “Method and apparatus for enhancement of chest compressions during CPR,” which is incorporated by reference herein in its entirety. The processor 152 and memory 154 may also be configured to cause the feedback device, such as the medical device 122, to provide guidance for the acute care provider 10 for administration of the chest compressions of scheduled depths over an initial compression period according to an initial compression protocol. As described in detail in connection with FIGS. 2A-2C, the initial compression protocol comprises a plurality of chest compressions of varying target depths, which may be set according to a particular schedule, with a first compression at an initial depth and a final compression at a final target depth greater in magnitude than the initial depth.

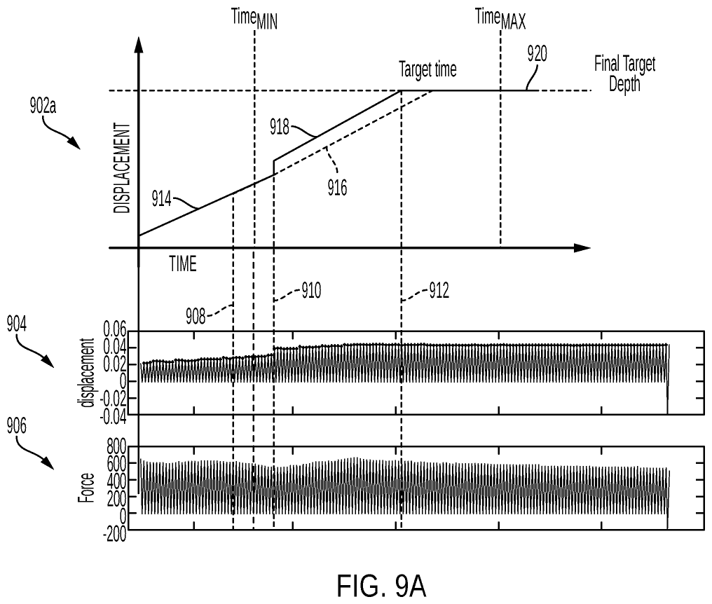

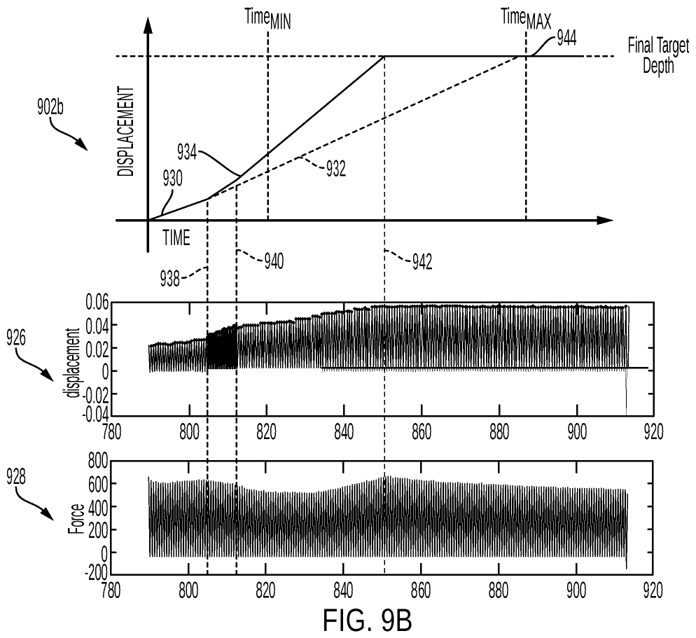

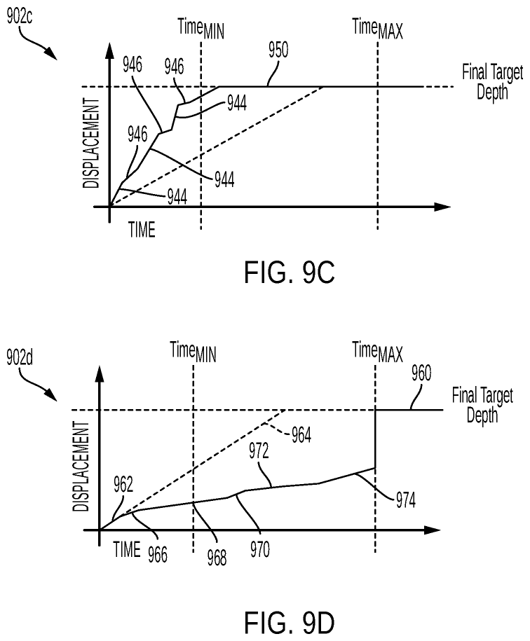

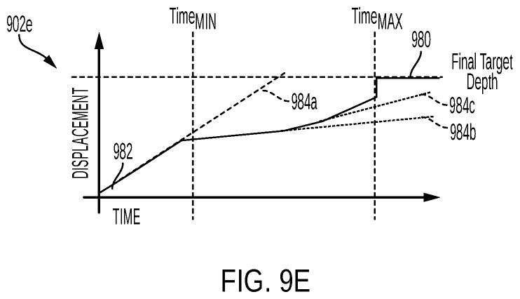

The processor 152 and memory 154 can also be configured to receive and process sensed force information from the force sensor 114 to estimate force applied to the chest 14 of the patient 12 during the chest compressions. As described in detail in connection with FIGS. 9A-9D, the processor 152 and memory 154 can be configured to automatically adjust a magnitude of the target depths to patient-specific depths for remaining chest compressions of the plurality of chest compressions of the initial compression protocol based on the estimated force applied to the patient's chest 14 during preceding chest compressions. By adjusting the target depths in this manner, guidance provided by the feedback device, such as the medical device 122, can be adapted for a particular patient 12 allowing the patient's chest 14 to acclimate to the chest compressions before compression depth substantially increases. As discussed previously, examples of visual displays for guiding performance of the chest compression according to the initial compression protocol are shown in FIGS. 3A, 3B, 6A, and 6B.

### Initial Compression Protocol Examples

FIGS. 2A-2C are graphs illustrating non-limiting examples of initial compression protocols 202a, 202b, 202c, 202d, 202e, which may comprise a chest compression ramp up procedure (or pattern or profile). Such initial compression protocols 202a, 202b, 202c, 202d, 202e can be implemented by the processor 152 and memory 154 of the system 110 for providing chest compressions to a patient over an initial chest compression period. The feedback device, such as the medical device 122, can be configured to provide feedback to guide or otherwise assist the acute care provider 10 in gradually increasing the depth of the chest compressions over the course of the initial compression period according to the protocol 202a, 202b, 202c, 202d, 202e. The protocols 202a, 202b, 202c, 202d, 202e can be about 30 seconds to 5 minutes in duration or, preferably, about 1 minute to 2 minutes in duration, for example. For various examples, at a typical compression rate of about 100-120 compressions per minute, these protocols 202a, 202b, 202c, 202d, 202e can comprise about 50 chest compressions to about 360 chest compressions or, preferably, about 100 chest compressions to 240 chest compressions.

These protocols 202a, 202b, 202c, 202d, 202e represent desired or scheduled target depths that the acute care provider 10 should aim to achieve for chest compressions during an initial compression period. In particular, the acute care provider 10 aims to increase compression depth from an initial compression depth 204 for a first compression of the protocol 202a, 202b, 202c, 202d, 202e to a final target compression depth 206 at the competition of the protocol. For example, the initial depth can be a depth of about 0.1 inch to 1.0 inch. The final target depth can be the America Heart Association (AHA) guideline depths, which are currently about 2.0 inches to about 2.4 includes (or 5-6 cm) for adults; approximately ⅓ the diameter of the chest of the child, which can be about 2.0 inches (5 centimeters) for a child; and about 1.5 inches (4 centimeters) for infants. However, the final target depth or final target range may vary from these guidelines.

As detailed above, the goal of using the initial compression protocol 202a, 202b, 202c, 202d, 202e is to slowly or gradually increase the displacement (depth) of the patient's chest 14 over time. A benefit of using an initial compression protocol 202a, 202b, 202c, 202d, 202e comprising a ramp up procedure is to provide a “break-in” period for the patient's chest 14. That is, the chest 14 is able to acclimate to the chest compressions, which may reduce or eliminate injuries caused by chest compressions (e.g., broken ribs or sternum) and help the chest 14 to retain its elasticity and structural integrity, which may help chest compressions maintain effectiveness, or to become even more effective than if the break-in period were not implemented, throughout the duration of the resuscitation. As noted herein, the initial compression protocol 202a, 202b, 202c, 202d, 202e may be applicable in providing feedback for a caregiver administering manual chest compressions, or the initial compression protocol 202a may be applicable as input for an automated chest compressor to administer compressions according to the initial compression protocol.

FIG. 2A is a graph of a linear chest compression protocol 202a. In a linear compression protocol, as shown by line segment 208, the scheduled depths for the chest compressions of the protocol 202a increase at a substantially constant rate (e.g., the schedule depth for each chest compression increases by a constant predetermined amount compared to the immediately preceding chest compression) for the entire duration of the protocol 202a, from the first compression at the initial compression depth 204, to the final compression, at the final target compression depth 206. For illustrative purposes, the protocol 202a is illustrated as the solid line segment 208, which represents the scheduled depths for the plurality of chest compressions of the protocol 202a. However, as will be appreciated by those skilled in the art, the protocol 202a actually comprises a series of chest compressions to be performed over time at varying scheduled (e.g., predetermined) depths.

As discussed previously, the 2015 AHA guidelines indicate that chest compressions should be delivered at approximately 100-120 times per minute and that a depth of 2.0 to 2.4 inches should be achieved. In accordance with these guidelines, by way of example, the initial treatment protocol 202a may achieve a final target depth of 2.0 inches in an initial compression period of 60 seconds. In order to achieve this result, each chest compression should be increased by 0.02 inches per compression (i.e., 2 inches divided by 100 compressions per minute). In alternative examples, the chest compression rate could be any rate between 100 and 120 compressions per minute, and the final depth could be any depth between 0.5 inches and 5.0 inches (e.g., between 2.0 inches and 2.4 inches). The initial compression period may be, for example, from 20 seconds to 2 minutes (or longer) in duration. Target depth ranges may change over time, depending on modified guidelines and/or customized chest compression protocols that are specifically tailored for each patient.

FIGS. 2A-2C further include points in time labeled “Timeₘᵢₙ” and “Timeₘₐₓ”, which operate as upper and lower boundaries for the initial compression period. The lower boundary, shown by Timeₘᵢₙ, represents a minimum amount of time or number of compressions that should be performed before achieving (e.g., beginning to perform) chest compressions at the final target depth 206 or final target depth range, for example, in the case of feedback for manual compressions. The amount of time or number of compressions for Timeₘᵢₙ may be an experimentally determined value representing a minimum amount of time or number of compressions needed for a patient's chest to acclimate to chest compressions for a wide variety of patient sizes and body types. While every human patient may have a unique physiology, Timers may operate as a safety precaution to ensure that the initial compression protocol 202a, 202b, 202c or ramp up protocol is applied for some minimal amount of time before chest compressions at the final target depth are performed. As no two people will have identical physiologies (e.g., amounts of fat, muscle, and/or chest compliance/elasticity), Timeₘᵢₙ could be set to 5 seconds (8 compressions), 10 seconds (17 compressions), 20 seconds (33 compressions), 25 seconds (42 compressions), 30 seconds (50 compressions), 35 seconds (58 compressions), 40 seconds (66 compressions), 45 seconds (75 compressions), 50 seconds (83 compressions), 55 seconds (92 compressions), 60 seconds (100 compressions), or more.

Similarly, the Timeₘₐₓ represents a maximum amount of time or maximum number of compressions for which the initial compression protocol 202a, 202b, 202c, 202d, 202e or ramp up protocol should be performed before switching to chest compressions performed at the final target depth 206 or final target depth range, for example, in the case of feedback for manual compressions. Limiting the maximum time or number of compressions for the initial compression protocol 202a, 202b, 202c, 202d, 202e ensures that chest compressions of sufficient depth to ensure sufficient blood flow begin to be provided to the patient within a medically beneficial amount of time. As detailed above, no two patients will have identical physiologies, thus the Timeₘₐₓ may be set to 30 seconds (50 compressions), 35 seconds (58 compressions), 40 seconds (66 compressions), 45 seconds (75 compressions), 50 seconds (83 compressions), 55 seconds (92 compressions), 60 seconds (100 compressions), 90 seconds (150 compressions), 120 seconds (200 compressions), or 180 seconds (250 compressions), or more.

With specific reference to FIG. 2B, a step-wise compression protocol 202b comprises multiple segments 210, 212, 214, 216, with compressions at different scheduled depths. As illustrated, the target depths for all chest compressions of one segment 210, 212, 214, 216 are the same. For example, the protocol 202b can include the first step or segment 210 in which compressions are provided at the initial compression depth 204 (e.g., a scheduled depth of from about 0.1 inch to about 1.0 inch). After a period of time and/or after a number of compression are completed, the scheduled or temporary target depth increases to the second segment 212 in the sequence, in which chest compressions are provided at an intermediate depth. After predetermined periods of time, the protocol 202b progresses to the third segment 214 and the fourth segment 216. The scheduled depths for the second, third, and fourth segments 212, 214, 216 can be intermediate depths ranging from about 0.5 inch to about 2.0 inches. Following the initial compression period, the chest compression depth increases to the final target depth 206 (e.g., from 2.0 inches to 2.4 inches). The length or duration of each step or segment 210, 212, 214, 216 may be based on time (e.g., 5, 10, or 15 seconds) or based on a predetermined number of compressions (e.g., 3, 5, 10, 15 compressions). As before, Timeₘₐₓ and Timeₘᵢₙ boundaries could also be implemented.

As shown in FIG. 2B, periods of time for each of the steps or segments 210, 212, 214, 216 may be substantially equal. In other examples, the duration of periods of time for each of the steps or segments 210, 212, 214, 216 may vary. For example, it may be preferable for certain steps to have shorter or longer periods of time relative to one another. As an example, for a patient with a stiff chest, it may be preferable for early steps or segments (e.g., segments 210, 212) of the protocol 202b to be longer in duration than latter steps or segments (e.g., segments 214, 216) of the protocol 202b, so as to allow the chest to soften before administering excessive compression force. Similarly, the increase in target depth between each of the steps or segments 210, 212, 214, 216 may be equal (e.g., the target depth may increase by 0.5 inch between each segment 210, 212, 214, 216), as shown in FIG. 2B. Alternatively, the change in target depths between steps or segments 210, 212, 214, 216 may vary. For instances where the target compression depth dynamically changes, such as in the example described with respect to FIG. 9C, the time period for each step or segment 210, 212, 214, 216 of the protocol 202b and/or the degree of increase for the target compression depths between steps or segments 210, 212, 214, 216 may be tailored to the patient mechanical response.

In one example, the processor 152 and memory 154 of the system 110 may be configured to adjust a duration of the segments 210, 212, 214, 216 based on a quality of chest compressions provided by the acute care provider 10. For example, the system 110 may monitor whether the acute care provider 10 successfully performs chest compressions of the scheduled target depths by comparing measured parameters for each chest compression to the scheduled target depth for the chest compression. The processor 152 and memory 154 may be configured to only continue to the next step or segment 212, 214, 216 when the acute care provider 10 successfully performs a predetermined number of chest compressions at the scheduled target depth for the current step or segment 210, 212, 214. However, the maximum time boundary Timeₘₐₓ can still apply. Accordingly, the processor 152 and memory 154 can be configured to begin providing instructions to perform chest compressions at the final target depth 206 after the maximum time Timeₘₐₓ, even if the acute care provider 10 has not finished all the steps or segments 210, 212, 214, 216 of the protocol 202b in the allotted time.

With reference to FIG. 2C, an exponential or substantially exponential initial compression protocol 202c is shown, in which the scheduled depths increase exponentially from the initial depth 204 to the final target depth 206. In this example, the chest compressions are implemented with a very gradual increase in target depth for a first portion (shown by shape 218) of the protocol 202c compared to the example protocols 202a, 202b in FIGS. 2A and 2B. This portion 218, where target depth increases gradually, may reduce injuries at the start of chest compressions compared to more aggressive initial compression protocols by providing a relatively slow rate of increase in the target depth of chest compressions. After an amount of time or number of compressions, the rate at which the compression depth increases becomes much more rapid, as shown by the portion enclosed by shape 220. Beneficially, this rapid increase in depth only occurs after the chest has had a substantial amount of time to acclimate to the chest compressions.

Similarly, for certain examples, an initial compression protocol 202d may employ a substantially logarithmic profile, including an initial relatively fast rate of increase in the target depth of chest compressions, followed by a slower rate of increase in the target depth of compressions. A logarithmic profile may be beneficial because increasing the target compression depth may be more physiologically beneficial early on during the ramp up period to move blood through the circulatory system during initial chest compressions. Or, in certain examples, an initial compression protocol 202e may comprise a combination of profiles. For example, after reaching an intermediate target compression depth (e.g., about 1.0 inch), it may be preferable to slightly ease the overall force of compressions so as to reduce the risk of breaking the ribcage. Once the ribcage is suitably conditioned, then it may be preferable to increase the target compression depth at a relatively faster rate.

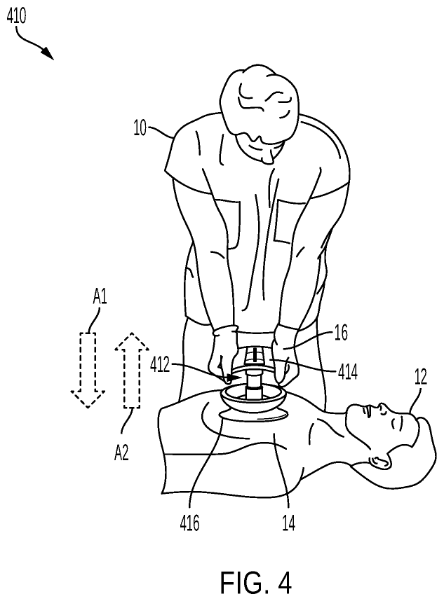

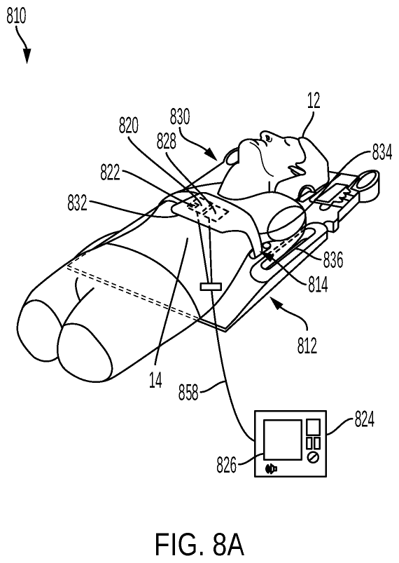

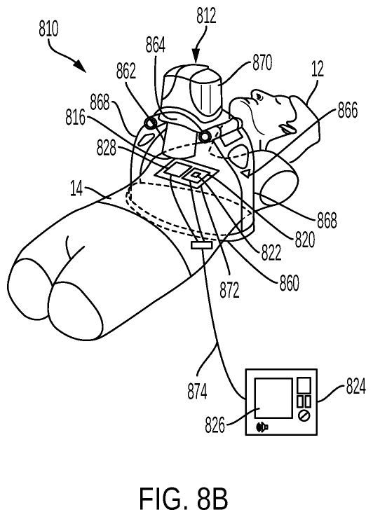

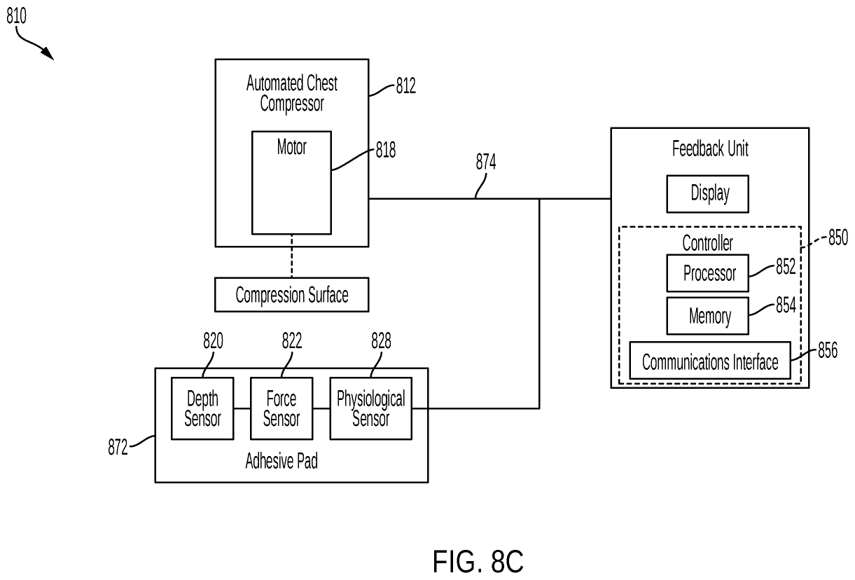

While these illustrated examples are described with respect to manual chest compressions performed by the acute care provider 10, any of these initial compression protocols 202a, 202b, 202c, 202d, 202e shown in FIGS. 2A-2C and/or profiles described herein could also be applied to ACD based chest compressions using the ACD device shown in FIG. 4 and/or the automated chest compressors, such as the exemplary automated chest compressors shown in FIGS. 8A and 8B.

### Chest Compression Feedback and Visual Displays

As discussed previously, feedback from the system 110 can be provided on a display 128 of a medical device 122. Examples of user interfaces 310 comprising visual indicators and icons shown on the display 128 for providing feedback about chest compressions and, in particular, for guiding the acute care provide 10 in performing chest compressions according to an initial compression protocol, are shown in FIGS. 3A and 3B. The portion of the display 128 providing guidance to the acute care provider 10 about the chest compression depth is referred to as a CPR dashboard 312. Other portions 314, 316 of the interface 310 may provide additional information about other aspects of resuscitation activities performed for the patient, patient physiological information, and/or information about the rescue effort. The user interface 310 can comprise visual indicators for chest compression parameters other than depth. For example, the portion 314 of the interface 310 to the right of the CPR dashboard 312 shows numerical values for compression rate.

With specific reference to FIG. 3A, the CPR dashboard 312 portion of the interface 310 comprises a graduated depth scale 318 comprising multiple depth indicator bars 320 arranged on top of one another. The depth indicator bars 320 can be virtual shapes shown on the display 128, which change in appearance (e.g., change color, texture, or outline thickness) to indicate a current depth for a chest compression being performed by the acute care provider 10. In other examples, the indicator bars 320 can be actual light bulbs or light emitting diodes (LEDs) that illuminate to convey information about the current compression depth. The CPR dashboard 312 also includes graduated numerical values 322 showing compression depths from 0 to 1.0 inch. The graduated numerical values 322 can be dynamic, and can change as the magnitude of the scheduled compression depth for remaining chest compressions of the initial compression protocol 202a, 202b, 202c, changes. For example, during the initial compressions (e.g., early in the initial compression protocol), the graduated depths can be between 0.0 and 1.0 inch, as shown in FIG. 3A. Near the end of the initial compression protocol or when the final target depth has been achieved, the graduated numerical values 322 can be from 0.0 to 2.5 inches, as shown in FIG. 3B.

The CPR dashboard 312 further comprises a dynamic indicator, such as a window 324, showing a target depth for a chest compression to be performed by the acute care provider 10. In FIG. 3A, the window 324 is positioned at 0.5 inch, indicating that the acute care provider 10 should perform a chest compression with a depth of 0.5 inch. The acute care provider 10 is instructed to release the chest compression when the depth indicator bar 320 enclosed by the window 324 is illuminated. In some instances, the window 324 is sized to enclose an acceptable range of depths for a chest compression provided by the acute care provider 10. For example, the window 324 can comprise a first side 326 indicating a minimal acceptable depth related to the scheduled chest compression depth and a second side 328 indicating a maximum acceptable depth related to the scheduled depth. For example, the minimum and maximum acceptable depths can be depths within about 20%, 15%, 10%, or 5% of a scheduled depth for a particular compression.

While not illustrated in FIGS. 3A and 3B, the CPR dashboard 312 may also comprise indicators showing when a chest compression has gone too deep. For example, the depth indicator bars 320 may change in appearance when a measured depth for a chest compression is 5%, 10%, or 15% greater than the target depth for the compression. In particular, the depth indicator bars 320 may change color or flash on and off to indicate that a compression has gone too deep. For example, the standard color for the bars may be green. Illuminated indicator bars 320 may turn red or orange and flash on and off when a compression is too deep. This color change provides another visual indicator that compressions are not being performed properly. Similarly, if the chest compressions are not deep enough, then the bars may turn to yellow or an audible or visual alert may be presented to indicate that chest compressions should be deeper. As an example, the medical device 122 may emit a sound through the speaker 130 in the form of a metronome to guide the acute care provider in the proper depth and rate of applying CPR compressions.

As discussed previously, the graduated numerical values 322 and/or window 324 are dynamic indicators, meaning that a position and/or appearance of the scale 318 and/or window 324 can be automatically adjusted on the display 128 following each chest compression or each group of chest compressions to indicate to the acute care provider 10 that a future compression(s) should be performed at different scheduled depths. Changes in numerical values 322 and position of the window 324 are shown by comparing the dashboard in FIG. 3A and the dashboard in FIG. 3B. In particular, as the target depth increases (e.g., from 0.5 inch in FIG. 3A to 2.0 inches in FIG. 3B) over the course of the initial compression protocol, the CPR dashboard 312 is updated to adjust the appearance of the graduated numerical values 322 and the position of the window 324. In particular, the range shown by the graduated numerical values 322 increases from 1.0 inch in FIG. 3A to 2.5 inches in FIG. 3B. In this way, the CPR dashboard 312 provides feedback with additional granularity for smaller compression depths, as shown in FIG. 3A, and also provides feedback for full depth chest compressions, as shown in FIG. 3B.

In some examples, the medical device 122 can also be configured to provide visual or audible feedback instructing the acute care provider 10 about certain aspects of providing chest compressions. For example, the medical device 122 may provide a reminder to “release” in situations where the acute care provider 10 is performing improper release. In particular, an ill-trained, naïve or fatigued acute care provider 10 may lean forward on the chest 14 of a patient 12 and not sufficiently release pressure on the sternum of the patient 12 at the top of each decompression stroke, which may reduce the effectiveness of the chest compressions. The reminder could by a visual pop-up notification on the CPR dashboard 312 portion of the user interface 310. Similarly, the medical device 122 may provide spoken and/or tonal audible feedback and/or haptic feedback reminding the acute care provider 10 to fully release the patient's chest 14.

As shown in FIGS. 3A and 3B, the interface 310 can further comprise a patient physiological information portion 316. Patient physiological information commonly displayed by medical devices 122 can comprise, for example, an ECG waveform 330. The patient physiological information shown on the portion 316 can further comprise, for example, measurements for non-invasive blood pressure, SO₂, ETCO₂, and heart rate measurements for the patient.

Another exemplary interface 310 for providing feedback about chest compressions and for guiding the acute care provide 10 in performing chest compressions according to an initial compression protocol is shown in FIG. 3C. As shown in FIG. 3C, the interface 310 comprises the scale 318 and depth bar indicators 320. The interface 310 further comprises the graduated numerical values 322 and the window 324. Unlike in previous examples, in FIG. 3C, the window 324 is arranged to provide feedback in such a manner that it is not readily apparent to the caregiver administering chest compressions that the target compression depth is increasing according to the initial compression protocol during the ramp up period. For example, as shown in FIG. 3C, the target window 324 is statically set such that no matter how the target compression depth changes, the target window 324 remains at the same desired region of the display scale 318. Accordingly, the display indicator bars 320 may fill as the caregiver performs compressions, and the caregiver may continue to administer compressions so that the indicator 320 fills to the statically set target window 324. As the ramp up period progresses, the target compression depth corresponding to the target window 324 dynamically increases according to the initial chest compression protocol. However, even as the target compression depth increases, an appearance of the interface 310 and, in particular, the position of the window 324 does not change.

For example, in FIG. 3C, the window 324 represents a target depth of 0.5 inch, as shown by the graduated numerical values 322. As the caregiver continues to provide chest compressions, the numerical values 322 may dynamically increase to a final target depth (e.g., 2.0 inches to 2.4 inches), while the position of the window 324 on the display scale 318 does not change. In this manner, the caregiver is free from thinking about the ramp up period, but simply concentrates on performing compressions so that the indicator reaches the target window.

Another exemplary interface 310 is shown in FIGS. 3D and 3E. As shown in FIGS. 3D and 3E, the interface 310 comprises the scale 318, indicator bars 320, and window 324 representing the target compression depth. Unlike in previous examples, the interface 310 further comprises a protocol display 332 showing progress through the initial compression protocol. The protocol display 332 comprises a target compression depth curve 334, similar to the parabolic protocol 202c shown in FIG. 2C, and a tracker 336, which shows progress through the initial compression protocol. In FIG. 3D, the position of the tracker 336 indicates that chest compressions have recently started. Accordingly, the target compression depth is shallow. The shallow compression depth is also indicated by the graduated numerical valves 322 and the window 324 on the scale 318. In contrast, in FIG. 3E, the initial compression protocol is nearly complete, as shown by the position of the tracker 336. Accordingly, the target compression depth has substantially increased compared to in FIG. 3D as shown by the position of the window 324 and graduated numerical values 322 on the scale 318 in FIG. 3E. By providing the protocol display 332, the caregiver can see his or her progress through the initial compression protocol and can anticipate when chest compression depth begins to substantially increase. In particular, by observing the position of the tracker 336 and slope of the curve 334, the caregiver can appreciate whether the target compression depth for the next few compressions to be performed will remain about the same, or whether, when the slope of the curve 334 is steep, the target compression depth for subsequent compressions will be deeper and will likely require greater force and exertion by the caregiver.

### Systems and Devices for Active Compression-Decompression

With reference to FIG. 4, a system 410 for providing active compression-decompression can be adapted to provide compressions and decompressions according to an initial compression protocol. Active compression results in the application of positive intrathoracic pressure, leading to the ejection of blood out of the ventricles and away from the heart. Active decompression results in the application of negative intrathoracic pressure, which enhances venous return back to the heart. In the absence of active decompression, the chest passively returns to its neutral position during the release phase (i.e., the decompression phase) of the chest compression cycle. As used herein, the “neutral position” is defined as a position of the sternum when no force, either upward or downward, is applied to the chest. The exertion of the upward force (i.e., the active decompression) may increase the release velocity associated with the decompression as compared to the release velocity without active decompression. Such an increase in the release velocity may increase the negative intrathoracic pressure and, thereby, enhance venous flow into the heart and lungs from the peripheral venous vasculature of the patient. In other words, the active decompression may enhance venous return of blood to the heart to refill the cardiac chambers. The active decompression may also enhance ventilation in the patient's lungs.

As previously discussed, chest compressions of an initial compression protocol can also be provided manually using an active compression-decompression (ACD) device that provides active compression and decompression of the chest. Exemplary ACD devices that can be used to provide chest compressions according to the initial compression protocols disclosed herein are described, for example, in U.S. Pat. No. 8,702,633 entitled “Guided active compression decompression cardiopulmonary resuscitation systems and methods” and U.S. Pat. No. 9,724,266 entitled “Enhanced guided active compression decompression cardiopulmonary resuscitation systems and methods,” as well as in U.S. Patent Application Publication No. 2019/0255340 entitled “Active compression decompression resuscitation integrated treatment system,” which are incorporated by reference in their entirety.

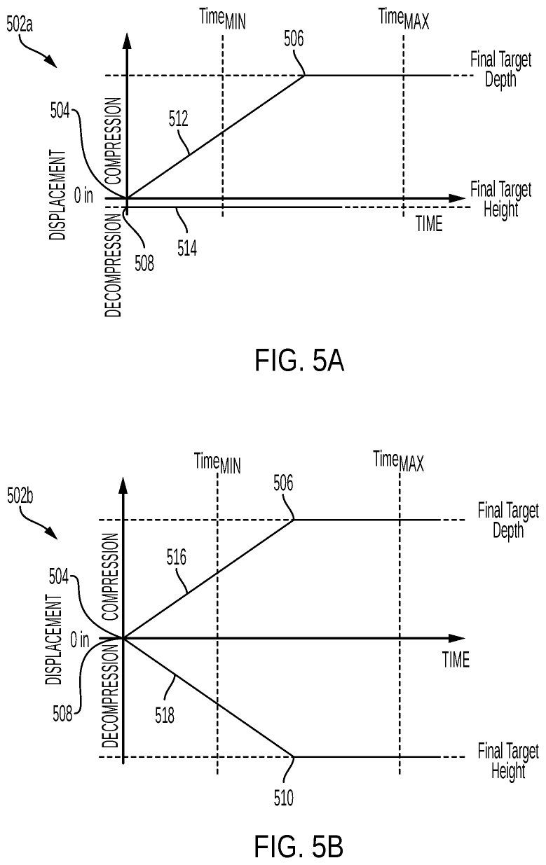

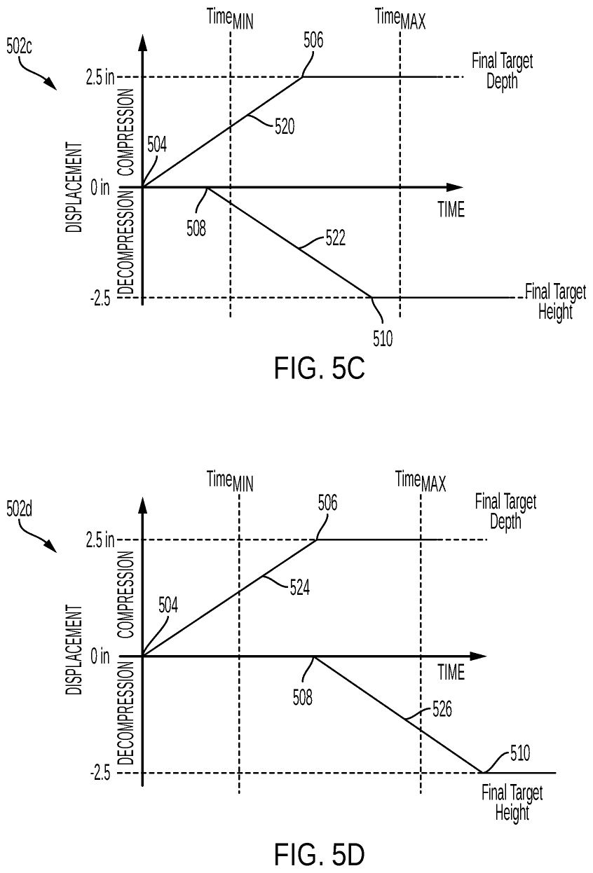

The system 410 for providing active compression-decompression according to an initial compression protocol 502a-502d (shown in FIGS. 5A-5D) comprises an ACD device 412, as shown in FIG. 4. The ACD device 412 is configured to provide both active compression and decompression. The chest decompression may cause the patient's chest 14 to recoil or expand at a faster release velocity than occurs naturally during standard chest compressions. Using the ACD device 412, the acute care provider 10 may also cause the patient's chest 14 to decompress or expand to a height, referred to herein as a “decompression height,” greater than the initial or natural chest position, which is referred to herein as the “neutral position.” Exemplary initial compression protocols 502a, 502b, 502c, 502d comprising both compression and decompression portions are shown in FIGS. 5A-5D.

In some examples, the ramp up period may be applicable for active compression decompressions. Physically speaking, the mechanical behavior associated with compression and decompression may differ from one another. For example, chest compliance during compressions and chest elasticity during chest lift or decompression may involve different parts of the chest and may require softening independent of each other. During compressions, tissues such as the ribcage, muscles, and underlying organs may soften and/or shift position as they are pushed downward. However, when pulled upward, such tissues may or may not be mechanically involved in resisting lift or decompression. In various embodiments, the target decompression height may be set according to instantaneous compliance calculations of the chest, which may be estimated based on force and displacement measurements for each compression/decompression (or group of compressions/decompressions averaged together). For example, a threshold of minimum instantaneous compliance may be set where the caregiver is provided with a warning or prompt that the risk of injury is elevated if the instantaneous compliance falls below the threshold. During decompressions, the instantaneous compliance of the chest is likely to decrease, particularly as the end of the free range of motion of sternal cartilage and thoracic cage is reached. In such examples, in the context of the ramp up period, the target decompression height may be set to gradually increase until the instantaneous compliance falls below a predetermined threshold.

With reference to FIG. 4, the ACD device 412 is a hand-held plunger device positioned on the chest 14 of the patient 12 for providing mechanically assisted chest compressions to the chest 14. The ACD device 412 comprises a handle 414, which is held in the hands 16 of the acute care provider 10. The ACD device 412 is shown held against the chest 14 of the patient 12. The configuration and geometry of the ACD device 412 enables the acute care provider 10 to use a similar body position and compression technique as in standard manual chest compressions (illustrated in FIG. 1A). In general, the ACD device 412 exerts a downward force, in a direction of arrow A1, to actively compress the chest 14 and an upward force, in a direction of arrow A2, to actively decompress the chest 14. The ACD device 412 may further comprise a suction cup 416 to affix the ACD device 412 to the chest 14 of the patient 12. Alternatively, the ACD device 412 may comprise adhesive pads, mechanism connection system, fasters, or other components that attach the ACD device 412 to the chest 14 to enable the exertion of the upward force by the hand-held ACD device 412.

The chest compression protocols 202a, 202b, 202c, 202d, 202e or patterns detailed in FIGS. 2A-2C (e.g., linear, step-wise, non-linear/exponential) could be applied to the patient 12 using the ACD device 412. Alternatively, initial compression protocols, such as the protocols 502a, 502b, 502c, 502d, shown in FIGS. 5A-5D, could be implemented that include both active compression portions and active decompression portions.

As in previous protocol examples, in FIGS. 5A-5D, the magnitude of the scheduled compression depth increases over the course of the initial compression protocol 502a, 502b, 502c, 502d, from the initial depth 504 to the final target depth 506. In a similar manner, a magnitude of the decompression height increases from an initial decompression height 508 to a target final decompression height 510 according to a stepwise, exponential, or curvilinear line or curve over the course of the protocols 502b, 502c, 502d. In the protocol 502a (shown in FIG. 5A), the decompression height is constant.

As was the case for FIGS. 2A-2C, the protocols 502a, 502b, 502c, 502d include the Timeₘᵢₙ and Timeₘₐₓ, which define the upper and lower boundaries for the duration of the initial compression protocol 502a, 502b, 502c, 502d. The Timeₘᵢₙ represents a minimum amount of time that chest compression/decompression should be performed before reaching the full or final target compression depth 506 for chest compressions and the final decompression height 510 for active decompression. Similarly, the Timeₘₐₓ represents a maximum amount of time for which chest compression/decompression should be performed before achieving the full or final target depth 506 for the chest compressions and the final target decompression height 510 for active decompressions. Similar to the profiles 202a, 202b, 202c, 202d, 202e in FIGS. 2A-2C, while not expressly shown in FIGS. 5A-5D, the profiles 502a, 502b, 502c, 502d for the ramp up for decompression may comprise linear, stepwise, exponential, logarithmic, curvilinear, piecewise, or curvilinear portions, or may fit other appropriate profiles.

With specific reference to FIG. 5A, the initial compression protocol 502a comprises a compression portion, shown by line segment 512, where a magnitude of the target compression depth increases linearly (e.g., at a constant rate) over the course of the protocol 502a. As was the case for FIGS. 2A-2C, while the illustrated graphs in FIGS. 5A-5D shows the protocol as solid and straight line(s) (such as the line segment 512), in operation, each line segment represents multiple chest compressions to be performed at scheduled or temporary target depths over the course of the protocol 502a. As noted previously, other non-linear profiles (e.g., stepwise, exponential, logarithmic, curvilinear, etc.) for the target chest compression depth may also be employed. Desirably, the acute care provider 10 aims to achieve the target depths and decompression heights during the chest compressions in order to gradually increase compression depth to achieve the final target depth 506 within the maximum time Timeₘₐₓ.

The acute care provider 10 is able to use the ACD device 412 to perform active decompressions on the patient 12. As shown in FIG. 5A, the initial compression protocol 502a comprises an active decompression portion, shown by line segment 514, comprising a small decompression (e.g., lift) of the chest 14 of the patient 12 throughout the initial compression period. For example, the decompression height for each of the active decompressions of the protocol 502a may be from 0.1 inch to 0.5 inch for the entire duration of the protocol 502a, as shown by the line segment 514. This small amount of decompression may help compensate for a natural loss of chest height and changes in shape of the patient's chest 14, which the patient 12 may incur during chest compression. Particularly, a diameter (e.g., anterior-posterior distance) of the patient's chest 14 may decrease over time due to the chest wall becoming more compliant in response to the repeated force applied by the chest compressions. Consequently, the chest compression depth may also decrease over time. That is, while the acute care provider 10 may achieve the proper depth on each compression, the chest wall may not return to its natural starting position, thereby lowering the depth by which the chest is actually compressed, reducing the effectiveness of the chest compressions over time. Or alternatively, in some cases, due to chest remodeling, compressions may run deeper than would otherwise be safe for the patient. Hence, it may be preferable to incorporate aspects of the present disclosure in providing a ramp up period of compressions and, optionally decompressions as well. By using the ACD device 412 and providing active decompressions with the slight lift, the acute care provider 10 is able to lift the patient's chest 14 back to, near or above the original starting position. In this way, there is minimal or no loss in effectiveness of the chest compressions over time.

With reference to FIG. 5B, the initial compression protocol 502b comprises a compression portion, shown by line segment 516, similar to in FIG. 5A, where the scheduled compression depth gradually increases in magnitude from the initial depth 504 to the final target depth 506 over the course of the initial compression period or ramp up period. The initial compression protocol 502b also comprises a gradually increasing active decompression portion, shown by line segment 518, where a magnitude of the scheduled decompression height for the chest decompressions increases linearly (e.g., at a constant rate) throughout the protocol 502b. In order to perform active chest decompressions as shown by line segment 518, the acute care provider 10 uses the ACD device 412 to lift the patient's chest 14 progressively higher for each chest decompression, ultimately achieving the final decompression height 510, which is equal in magnitude the final target compression depth 506, as shown in FIG. 5B.

It will be appreciated, however, that the examples in FIGS. 5A and 5B are for illustrative purposes only. Protocols may be implemented where the final target depth 506 and final target decompression height 510 are different magnitudes. Likewise, patient physiologies will often affect how quickly the final target decompression height 510 and final target compression depth 506 can be achieved. Thus, while the portions of the protocol 502b shown by line segments 516, 518 are symmetrical linear progressions, the final target compression depth 506 and final decompression height 510 may not be achieved at the same time, or may be achieved at substantially the same time, yet having different slopes or profiles relative to one another. For example, anthropometric measurements of the patient, force measurements for the chest compressions, physiological measurements for the patient, and/or measurements related to a quality of chest compressions performed by the acute care provider 10 (e.g., whether the acute care provider is achieving the scheduled compression depth and/or decompression height for the chest compressions of the protocol 502a, 502b) may be used to adjust the protocol 502a, 502b either before starting chest compressions or in real-time, as chest compressions are being provided to the patient 12. As an example, an initial compression protocol may be adjusted when a bystander (e.g., a layperson providing CPR before trained EMS personnel arrive) has been providing CPR to the patient for an extended period (e.g., about 10 minutes or longer). In such cases, it may be preferable to skip the initial compression protocol and ramp up period altogether. As discussed previously, other non-linear profiles (e.g., stepwise, exponential, logarithmic, curvilinear, etc.) for the target chest compression depth and/or decompression height may also be employed, as the illustrated linear profile is intended to be schematic and non-limiting in nature.

With reference to FIGS. 5C and 5D, as illustrative embodiments, the initial compression protocols 502c, 502d comprise gradually increasing linear chest compression portions, shown by line segments 520, 524, which are similar to the previously described examples. The initial compression protocols 502c, 502d also comprise active decompression portions 522, 526, in which the scheduled decompression height gradually increases in magnitude over the course of the protocol 502c, 502d. In these examples, however, the active decompression portion (e.g., lifts) (shown by the line segments 522, 526) are initiated at a period of time after starting the compression portion (shown by the line segments 520, 522). For example, in FIG. 5C, the active decompression portion (line segment 522) begins at point 508 when the scheduled depth for the compression portion (line segment 520) is approximately halfway to the final target compression depth 506. In FIG. 5D, the active decompression portion (line segment 526) begins at point 508 after the schedule depth for the chest compressions reaches the final target compression depth 506. In such a situation, during the ramp up period, it may be preferable for the caregiver to focus on reaching the preferred target compression depth before being concerned about the decompression height. As discussed above, other non-linear profiles (e.g., stepwise, exponential, logarithmic, curvilinear, etc.) for the target chest compression depth and/or decompression height may be employed, as the illustrated linear profile is intended to be schematic and non-limiting in nature.

### Displays and Interfaces for Active Compression-Decompression Feedback

The ACD device 412 of system 410 may be equipped to provide real-time feedback to the acute care provider 10 to guide the acute care provider 10 in performing active chest compressions/decompressions according to the initial compression protocols 502a, 502b, 502c, 502d. As in previous examples, the feedback can comprise haptic feedback, audible feedback, and/or visual feedback. In order to provide visual feedback, the ACD device 410 comprises a display 428 located on an upwardly facing surface of the handle 414 that shows a user interface 610 to the acute care provider 10. Examples of user interfaces 610 are shown in FIGS. 6A and 6B.

The user interface 610 may be similar to the CPR dashboard 312 shown in FIGS. 3A and 3B. With reference to FIGS. 6A and 6B, the user interface 610 can comprise a graduated scale formed from aligned indicator bars 620. The indicator bars 620 change in appearance to show a current compression depth and current decompression height for a chest compression and decompression being performed for the patient 12. The bars 620 can be virtual shapes provided on the display 428. Alternatively, the bars 620 can be formed from light bulbs or LEDs that illuminate to convey information to the acute care provider 10.

The user interface 610 further comprises the graduated numerical values 622 indicating an actual depth or decompression height for the chest compressions and decompressions. The numerical values 622 also include a neutral point, indicated by 0.0. The numerical values 622 can be dynamic, changing in value as the scheduled depth for a compression and/or scheduled decompression height for a chest decompression changes. For example, the range for the numerical values 622 in FIG. 6A is −1.0 inch to 1.0 inch. In FIG. 6B, the numerical values 622 have a range from −2.5 inches to 2.5 inches.

As in previous examples, the interface 610 can comprise a visual indicator showing the scheduled target compression depth, such as a window 624. The interface 610 can also include a window 632 showing a scheduled target decompression height for a chest decompression to be performed. The interface 610 can be configured to adjust a position of the windows 624, 632 in accordance with the initial compression protocol following each compression or decompression. In some examples, the windows 624, 632 can include the first side 626, 634 showing the minimum acceptable compression depth or decompression height related to the scheduled target compression depth or target decompression height and a second side 628, 636 showing a maximum acceptable compression depth or decompression height related to the scheduled target compression depth and decompression height for each compression and decompression. As noted above in connection with FIG. 3C, the graduated numerical values and target window(s) may provide feedback in such a manner that it is not readily apparent to the caregiver administering chest compressions that the target compression depth and/or decompression height is varying according to the ramp up period. For example, the target window(s) may be statically set such that no matter how the target compression depth or target decompression height changes, the target window(s) remain at the same desired region of the display scale. Hence, the caregiver does not have to be distracted about the ramp up period, but is able to better concentrate on performing compressions so that the fill indicator(s) reach the respective target window(s).

As in previous examples, as the acute care provider 10 provides a chest compression to the patient 12, the bars 620 illuminate or change in appearance indicating a current depth for the compression. The acute care provider 10 is instructed to continue to compress the chest 14 of the patient 12 until the target compression depth is obtained, as shown when the indicator bar 620 enclosed by the window 624 illuminates or changes in appearance. The acute care provider 10 then pulls up on the handles 414 of the ACD device 412 for active decompression. As the chest moves from the compressed position to the neutral point, the various indicator bars 620 turn off or change color. Once the neutral point is reached, the acute care provider 10 continues to lift up on the handles 414 to the target decompression height, such as a decompression height of 0.6 inch (in FIG. 6A) or 1.5 inches (in FIG. 6B). As the ACD device 412 is lifted from the neutral position, the illuminator bars 620 are illuminated or change color to signal the current decompression height. The acute care provider 10 is instructed to continue lifting up on the handles 414 until the target decompression height is achieved, as shown when the indicator bar 620 enclosed by the window 632 changes in appearance (e.g., changes color or illuminates).

While not illustrated, as in previous examples, the indicator bars 620 may also change in appearance to indicate when the compression has gone too deep or the chest is lifted above the target decompression height. For example, each indicator bar 620 may change from no color to green as the acute care provider 110 compresses the patient's chest 14. If the acute care provider exceeds the target depth, as shown by window 624, the color of the indicator bars 620 may change to orange or red. The indicator bars 620 may also flash to indicate that a compression has gone too deep.

As in previous examples, the ACD device 412 may further comprise a speaker 430 to provide verbal instructions encouraging the acute care provider 10 to adjust how chest compressions/decompressions are being performed. For example, the speaker 430 may emit reminders or notification, such as a reminder instructing the acute care provider 10 to “Increase Speed” or “Lift Faster” if decompressions are not occurring at a selected rate.

### Patient-Specific Compression Protocols for Manual Chest Compressions

The chest compression systems 110, 410 described herein are configured to guide the acute care provider in performing chest compressions according to the initial compression protocol. As discussed previously, certain measured parameters can be used to adjust the initial compression protocol in real time so that, for some patients, the final target compression depth or final target decompression height can be achieved more quickly than provided by a predetermined initial compression protocol. For example, force measurements, such as force measurements from the force sensor 114 (shown in FIGS. 1A and 1B), may be used to adjust target depths for remaining chest compressions of the initial chest compression protocol.

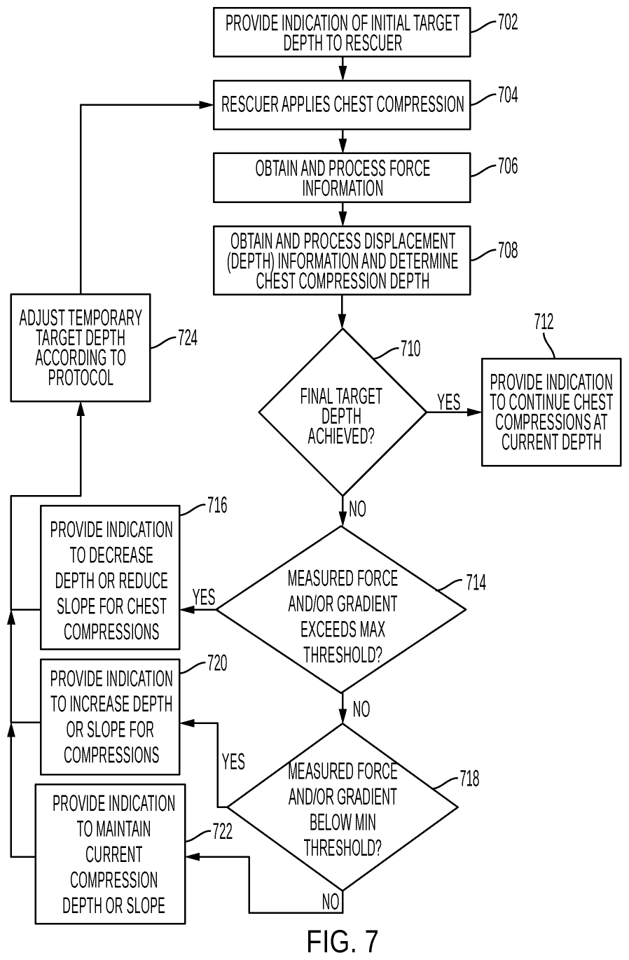

FIG. 7 is a flowchart illustrating one example of how the initial compression protocol is implemented and adjusted in real time in conjunction with manual chest compression and/or active compression-decompression using an ACD device 412. As detailed previously, a goal of implementing the gradually increasing chest compressions in the initial compression protocol(s) is to slowly increase the displacement (or chest compression depth) until the final target compression depth is reached. Once the final target compression depth is reached, chest compressions at the final target compression depth can be provided to the patient 12 until chest compressions are no longer needed. Accordingly, it is beneficial to achieve the final target compression depth as quickly (and safely) as possible.

For illustrative purposes, FIG. 7 will be described with respect to the system 110 shown in FIGS. 1A and 1B. That is, with manual chest compression provided by an acute care provider 10 using a hand-held sensor device 116 that provides data to a medical device 122. However, it will be understood that similar steps may be implemented for assisted active compression-decompression, using the ACD device 412 shown in FIG. 4. Likewise, as illustrated in FIGS. 2A-2C and 5A-5D, there are many initial compression protocols that could be implemented using the techniques and processes described in connection with FIG. 7. For illustrative purposes, FIG. 7 will be described with respect to the step-wise chest compression protocol of FIG. 2B.

With reference to FIG. 7, in step 702, the medical device 122 provides an indication to the acute care provider 10 to perform chest compressions at an initial compression depth according to an initial compression protocol. The initial depth is usually a small value (e.g., about 0.1 inch to 1.0 inch), which is less than half of the final target depth. As illustrated in FIG. 3A, the initial compression depth can be displayed to the acute care provider 10 by illuminating portions of the depth indicator bars 320 and window 324 of the CPR dashboard 312.

Typically, the initial compression protocol, which may comprise a procedure for ramping up the compression target depth over the protocol period, is applied to patients who have not yet received chest compressions. In that case, the initial target depth may be a depth measured from a natural position of the patient's chest 14, such as an initial position of the patient's chest 14 before chest compressions. Alternatively, in some cases, an initial compression protocol comprising a procedure for ramping up target compression depth may be applied in situations where the patient 12 has already been receiving chest compressions. For example, chest compressions or CPR may be applied by untrained individuals (e.g., laypersons) prior to the arrival of a medical professionals (EMT, Paramedics, acute care providers, doctors, nurses, and/or first responders) to a rescue scene. The untrained lay persons may have provided chest compressions that were too shallow and not in compliance with the AHA (American Heart Association) Guidelines. Accordingly, despite CPR having been applied, it may still be desirable to employ an initial compression protocol for ramping up the target compression depth. As discussed previously, the 2015 AHA guidelines for compression depth are between 2.0 and 2.4 (or 5-6 cm) inches for adults; approximately ⅓ the diameter of the chest of the child or about 2 inches (5 centimeters) for a child; and about 1.5 inches (4 centimeters) for infants. In this case, the initial target depth may be measured from a depth of the shallow chest compressions provided by the lay person. In this way, over the course of the initial compression protocol, the patient's chest 14 acclimates from relatively shallow chest compressions (provided by the lay person) to full depth chest compressions in compliance with the 2015 AHA guidelines, in a safe manner while reducing risk of injury to the patient 12.

Next, in step 704, the acute care provider 10 applies manual chest compressions to the patient 12. As chest compressions are being applied, in step 706, the processor 152, such as the processor of the medical device 122, obtains and processes force information from the force sensor 114. Similarly, at step 708, the processor 152 obtains and processes displacement information from the depth sensor 112 to determine a chest compression depth for chest compressions provided to the patient 12.

In step 710, the processor 152 determines if a final target compression depth has been achieved. This may be determined from a simple comparison between the measured compression depth determined in step 708 and the final target depth. If the final target compression depth has been achieved, in step 712, the processor 152 can cause the medical device 122 to provide an indication that the final target compression depth has been achieved. Also, the processor 152 can cause the medical device 122 to provide feedback instructing the acute care provider 10 to continue providing chest compressions at the achieved final target compression depth for a predetermined or indeterminate amount of time. For example, chest compressions at the final target depth can continue to be performed for the remaining period of the resuscitation (e.g., for periods during which compressions are to be applied) until chest compressions are no longer needed for the patient 12. This step is effectively the cross-over point for switching from the initial compression protocol which comprises a ramp up procedure to providing chest compressions at the final target depth.

If the final target compression depth has not yet been achieved, the processor 152 is then configured to continue to provide chest compression feedback according to the initial compression protocol. The processor 152 may also adjust a magnitude of the target compression depths to patient-specific depths for remaining chest compressions of the initial compression protocol based on the estimated force measurements determined at step 706.

Given that chest compliance may vary from person to person and the force associated with a given depth will also vary for different people, the manner in which the measured force or compliance of the patient changes during the ramp up period may be used to determine how the chest is softening or remodeling due to the applied compressions and/or whether the patient is at an increased risk of injury. Accordingly, changes in measured force and compliance can affect how target compression depths (and thus, feedback for manually provided CPR) are adjusted to be patient-specific.

In order to adjust the target depths to patient-specific target depths, at step 714, the processor 152 is configured to use the displacement and force sensor input to determine how the target depth should be modified so as to be customized to the patient. For example, the processor 152 may be configured to determine whether the measured force and/or the change in measured force (e.g., force gradient) for one or more preceding chest compressions exceeds a maximum threshold. Further, the processor 152 may be configured to determine whether the measured force or change in measured force (e.g., force gradient) exceeds a predetermined acceptable range of forces or force gradients that can be exerted on the patient's chest without causing injury. If the measured force or change in measured force exceeds a predetermined threshold, for example, then it may be desirable to decrease the amount of force applied to the patient's chest, or provide chest compressions in a more gentle fashion. For example, the feedback system may reduce the increase in target compression depth (e.g., reduce a slope of the protocol line for target chest compression depths) so that the ramp up in target compression depth is more gradual. When the maximum threshold for force or force gradient is exceeded, the target compression depth may increase only a smaller amount than would otherwise be the case, may remain constant for a period of time rather than increase in magnitude, or may even slightly decrease for a period of time so that even less force is applied to the patient.

In one example, the maximum threshold of force applied to the thorax could be set according to a predefined limit (e.g., between 20 kg and 60 kg, between 30 kg and 50 kg for compressions; between 5 kg and 20 kg, between 10 kg and 15 kg for decompressions). In other examples, the maximum threshold of force gradient or change in force for compressions and/or decompressions could be a percentage (e.g., 20%, 25%, 30%, 35%, 45%, or less than 50%) of the previous measured force value. Exceeding that maximum threshold of force and/or force gradient for compressions and/or decompressions may provide an indication that the acute care provider 10 is in danger of injuring the patient 12.

If the measured force and/or change in measured force (force gradient) exceeds the maximum threshold, the processor 152 can be configured to adjust the magnitude of the target depths to patient-specific depths for remaining scheduled chest compressions of the initial compression protocol, as shown at step 716. For example, the processor 152 may reduce the magnitude and/or slope of a target compression depth to patient-specific depths (e.g., due to an indication that an excessive force or force gradient has been measured) for some or all remaining chest compressions of the protocol or a limited number of remaining chest compressions by a selected amount (e.g., reduce a magnitude of the scheduled target depth by 5%, 10%, 15% or another amount). In some examples, changes to the scheduled target compression depths for remaining chest compressions of the protocol can be linear or non-linear. In that case, the adjustment could include increasing or decreasing the scheduled target depth by a predetermined amount for each remaining chest compression, so that a relatively continuous linear or non-linear relationship between the chest compressions is maintained. In other examples, the adjustment could include increasing or decreasing the magnitude of the compression depth for only a few chest compressions and then returning to the predetermined scheduled target depths for other remaining chest compressions of the initial compression protocol.

As discussed previously, the processor 152 can be configured to automatically update the user display or dashboard to include the adjusted patient-specific target compression depths. Once the display 128 and user interface 310 are updated, the acute care provider 10 can proceed to provide chest compressions in accordance with the adjusted or patient-specific target depths.

In some examples, adjustments of the magnitude of the scheduled target depths to the patient-specific depths for the remaining chest compressions of the initial compression protocol is based on an estimated or measured chest compliance for the patient. Chest compliance can be estimated based on estimated force and estimated displacement for one or more preceding chest compressions.

The processor 152 can also be configured to increase the scheduled target depths for the remaining chest compressions of the initial compression protocol, so that the final target depth is achieved more quickly. The determination of when to increase compression depth more quickly than scheduled can also be based on force measurements. For example, in step 718, if the measured force and/or force gradient does not exceed respective maximum thresholds, then the processor 152 is configured to determine if the measured force and/or force gradient is below a respective minimum threshold. Similar to the measure of the maximum threshold, the minimum threshold for force could be a predefined limit (e.g., a force of less than 10 kg, less than 5 kg, or a force between 1 kg and 5 kg). In an alternative example, the minimum threshold of force gradient or change in force could be a percentage (e.g., 20%, 25%, 30%, 35%, 45%, or greater than 50%) of the previous measured force value. A substantial decrease in measured force for compressions of the same depth may indicate that the patient's chest is stretching or acclimating to the compressions, indicating that deeper compressions could be performed without causing injury to the patient.

If the measured force and/or force gradient is not below the minimum threshold, then the processor 152 may be configured to provide guidance to the acute care provider 10 instructing the acute care provider 10 to continue performing chest compressions at scheduled target depths according to the initial compression protocol, as shown at step 722. However, if the measured force and/or force gradient is below the threshold, at step 720, the processor 152 may be configured to adjust scheduled target depths to patient-specific depths for remaining chest compressions so that the final target compression depth is achieved faster. That is, the patient's chest may have quickly acclimated to the force of compressions, meaning that it may be preferable to move on from the ramp up period of compressions in order to move blood more effectively through the circulatory system.

As a further example, in order to determine how the patient-specific target depth may vary and, in particular, whether the chest has been sufficiently softened during the ramp up period, the processor 152 may be configured to track how the peak force changes for the patient over time or per compression. Initially, during the start of compressions, the patient's thorax may be relatively stiff, meaning that the peak compression force may be at its highest point during the course of the resuscitation. Over time, as more compressions are applied, the patient's chest may be softened and the measured peak compression force may decrease to a point where it reaches a mechanical steady state. Once this mechanical steady state has been reached, it may be determined that the patient's thorax has been adequately broken-in, such that the caregiver can then move on from the ramp up period to the final target depth of compressions. Accordingly, when the slope of the maximal (peak) compression force reaches a value that is less than a predetermined threshold (e.g., less than 10 pounds/minute), the processor 152 may be configured to provide a signal to indicate to the caregiver that sufficient break-in of the patient's chest has been achieved and that the caregiver may proceed to the final target depth. Similarly, the slope of the instantaneous compliance may also be used to determine whether the patient's chest has been sufficiently broken-in.

At step 724, the processor 152 is configured to provide feedback instructing the acute care provider 10 to provide chest compressions according to the adjusted protocol including the patient-specific target compression depths. As discussed previously, the feedback can be haptic, audible, or visual. For example, the feedback may comprise adjusting the appearance of the CPR dashboard 312, shown in FIGS. 3A and 3B. In particular, the graduations of numerical values 322 on the scale 318 may be changed, so that feedback about deeper compressions can be shown to the acute care provider 10. Also, a position of the window 324 may be adjusted instructing the acute care provider 10 to perform chest compressions at a new schedule or patient-specific target depth.

While not shown in FIG. 7, the scheduled or patient-specific compression target depths of the initial compression protocol may also be adjusted based on an elapsed time or number of compressions performed since chest compressions commenced. For example, as discussed previously, the processor 152 may be configured to ensure that at least a minimum amount of time (Timeₘᵢₙ) passes before the final target depth is achieved. Therefore, the processor 152 may be configured to delay increasing the magnitude of the scheduled target compression depth, even when force measurements are below the minimum threshold values, in order to avoid achieving the final target depth too quickly. Similarly, the processor 152 may be configured to increase the target compression depth faster near the end of the initial ramp up period, shown by Timeₘₐₓ, even when measured force or force gradient is greater than the maximum force or force gradient threshold value.

As shown in FIG. 7, the processor 152 is configured to continue providing feedback instructing the acute care provider 10 to perform chest compressions according to the initial compression protocol, modified based on force measurements, until the final target depth 206 is achieved. Once the final target depth 206 is achieved, as shown at step 712, the processor 152 is configured to provide guidance for the acute care provider 10 for administration of the chest compressions at the final target depth 206 for the remainder of the resuscitative effort. The acute care provider 10 may continue to perform chest compressions at the final target compression depth 206 until chest compressions are no longer needed and/or until other medical devices are provided and set-up at the rescue scene for providing other treatments to the patient 12. For example, the acute care provider 10 may continue performing manual chest compressions for the patient 12 until an automated chest compressor is set-up for performing automated chest compressions, until it may be required to pause compressions for a defibrillator to provide a defibrillation shock to the patient 12, or until the medical event is over (e.g., patient has achieved return of spontaneous circulation).

### Automated Chest Compressors and Systems

With reference to FIGS. 8A-8C, systems 810 comprising automated chest compressors 812 configured to be applied to the chest 14 of the patient 12 for administering patient-specific chest compressions to the patient 12 are illustrated.

A variety of different types of automated chest compressors 812 may be used with the systems 810. Automated chest compressors 812 generally comprise a compression surface, such as a belt 814 or pad 816, configured to be positioned on the patient's chest 14. The automated chest compressor 812 further comprises a driver configured to move the compression surface in a first direction to compress the patient's chest 14 and in a second direction to release the patient's chest 14. As described in further detail herein, the driver can be, for example, a motor 818, such as a belt-tensioner, for rotating a spindle (shown in FIG. 8A) to wind the belt 814 onto the spindle, thereby applying a chest compression. The motor 818 can also cause the spindle to rotate in an opposite direction to release the belt 814 and the chest compression. The motor 818 could also be a linear actuator configured to drive a piston 862 (shown in FIG. 8B) against the patient's chest 14 to perform a chest compression.

In some examples, the system 810 further comprises sensors for monitoring the performance of the chest compressions and/or a condition of the patient 14. For example, the system 810 can comprise a displacement or depth sensor 820 configured to directly measure distance traveled by the patient's chest 14 and/or the compression surface (e.g., the belt 814 or pad 816) to estimate a depth and/or decompression height for the chest compression. In some examples, the displacement or depth sensor 820 can be configured to measure a distance traveled by the piston 862 (shown in FIG. 8B). In other examples, for a belt arrangement (shown in FIG. 8A), the displacement or depth sensor 820 can measure, for example, how much of the belt 814 has retracted onto the spindle to estimate the depth of the compression. In other examples, the displacement sensor 820 can be a motion sensor (e.g., a velocity sensor or accelerometer) positioned on the patient's chest 14 for sensing movement of the chest 14 to estimate displacement of the chest during compressions.

The system 810 further comprises a force sensor 822 configured to sense force information for chest compressions. For example, the force sensor 822 can be a strain gauge, pressure sensor, or similar suitable electronic sensing device positioned on the patient's chest 14 configured to detect forces applied to the chest by the compression surface (e.g., the belt 814 or pad 816).

The system 810 can further comprise patient physiological sensors 828 for monitoring a condition of the patient 12 as chest compressions are being performed. As discussed previously, physiological sensors 828 can comprise, for example, cardiac sensing electrodes, ventilation sensor(s), and/or sensors capable of providing signals indicative of vital sign(s) of the patient 12, such as electrocardiogram (ECG), blood pressure (e.g., invasive blood pressure (IBP), non-invasive blood pressure (NIBP)), heart rate, pulse oxygen level, respiration rate, heart sounds, lung sounds, respiration sounds, end tidal CO₂, saturation of muscle oxygen (SMO₂), arterial oxygen saturation (SpO₂), cerebral blood flow, electroencephalogram (EEG) signals, brain oxygen level, tissue pH, tissue oxygenation, or tissue fluid levels

Automated chest compressors 812 are configured to provide automated chest compressions to the patient 14 according to certain settings (e.g., chest compression parameters) including, for example, compression depth, decompression height, compression rate, compression force, compression hold time, release velocity, downstroke acceleration, downstroke velocity, lift displacement, lift force, upstroke acceleration, and upstroke velocity. Automated chest compressors 812 generally utilize pre-programmed values for various chest compression parameters. For example, device manufacturers may determine suitable pre-programmed values for parameters, which can be stored in on-board memory of the chest compressor 812. In some examples, automated chest compressors 812 comprise user interfaces that allow users to select or adjust these pre-programmed values. In that case, the chest compressor 812 can include a feedback unit 824 comprising, for example, a display screen 826 showing an acute care provider (not shown in FIGS. 8A and 8B) current device settings, so the acute care provider can determine if the settings need to be adjusted.

In some case, these parameters may not be adjustable by the acute care provider once chest compressions commence, to avoid causing a distraction during treatment of the patient 14. If the settings or parameters cannot be adjusted during treatment, the feedback unit 824 or display screen 826 may be turned off to avoid causing confusion and/or anxiety for the acute care provider. In particular, providing feedback for non-adjustable parameters may undesirably lead the acute care provider to interfere with the delivery of the chest compressions in an unnecessary attempt to change these parameters.

The systems 810 further comprise controllers 850 for controlling operation of the automated chest compressor 812 and, in some cases, for providing feedback to the acute care provider. For example, the feedback unit 824 can comprise a controller 850, comprising a computer processor 852 and memory 854, configured to control operation of the chest compressor 812. In some examples, the processor 852 and memory 854 are configured to cause the driver (e.g., the motor 818 for driving the spindle or piston) of the chest compressor 812 to move the compression surface (e.g., the belt 814 or pad 816) in the first direction, such as a vertically downward direction, until a signal received from the displacement sensor 820 indicates that the compression surface has moved a sufficient distance to perform a chest compression according to the device settings or compression parameters. Once the compression depth is reached, the processor 852 and memory 854 can be configured to cause the driver, such as the motor 818, to move the compression surface in the second direction, such as a vertically upwards direction, to a target decompression height identified based on the signal from the at least one displacement sensor 820. For standard chest compressions, there is effectively no decompression height. For active chest compressions/decompressions, the decompression height can be a selected distance above the neutral or initial position for the chest compression.

In some examples, the automated chest compression systems 810 are configured to provide chest compressions according to an initial compression protocol, such as one of the initial compression protocols shown in FIGS. 2A-2C or FIGS. 5A-5D during an initial compression protocol or ramp up period. In order to implement such initial compression protocols, the processor 852 and memory 854 can be configured to, following each compression, adjust the target or scheduled compression depth and/or target or scheduled decompression height according to the predetermined initial compression protocol. Further, after completion of the predetermined number of chest compressions of the initial compression protocol, the processor 852 and memory 854 can be configured to cause the automated chest compressor 812 to provide chest compressions at a final target depth and/or final decompression height for a predetermined or indeterminate amount of time.

The processor 852 and memory 854 can also be configured to adjust the initial compression protocol during performance of the chest compressions to provide chest compressions at patient-specific depths and/or patient-specific decompression heights. For example, during performance of compressions by the automated chest compressor 812, the processor 852 and memory 854 can be configured to receive and process sensed force information from the force sensor 822 to estimate force applied to the chest 14 during the chest compressions. The processor 852 and memory 854 are further configured to adjust a magnitude of the scheduled depths for chest compressions to patient-specific depths for the remaining chest compressions of the initial compression protocol. The adjustment is based, at least in part, on the estimated force applied to the patient's chest during preceding chest compressions of the plurality of chest compressions. For example, as discussed previously, the processor 852 and memory 854 may be configured to compare force measurements for previous chest compressions to threshold minimum or maximum force values to determine whether to adjust the scheduled compression depth to patient-specific compression depths. The processor 852 and memory 854 may also be configured to adjust the scheduled compression depths based on a percentage change in measured force between preceding chest compressions. When the automated chest compressor 812 is used to provide active compression/decompression for the patient 12, the processor 852 and memory 854 can be configured to adjust the scheduled decompression height to a patient-specific decompression height for remaining decompressions based on force measurements, in a similar manner.

Having described components of automated compression systems 810 generally, specific features of different chest compression devices will now be described in detail. With specific reference to FIG. 8A, the automated chest compressor 812 can comprise a belt-based automatic compressor for providing automated mechanical chest compressions to the patient 12. One example of a belt-based chest compressor 812 is the ZOLL® AutoPulse®. Examples of belt-based chest compressors that can be adapted to provide chest compressions according to the initial compression protocols disclosed herein are described, for example, in U.S. Pat. No. 7,347,832 entitled “Lightweight electro-mechanical chest compression device,” U.S. Pat. No. 7,354,407 entitled “Methods and devices for attaching a belt cartridge to a chest compression device,” and U.S. Pat. No. 8,795,209 entitled “Chest compression belt with belt position monitoring system,” which are incorporated by reference in their entireties.

As shown in FIG. 8A, the belt-based chest compressor 812 comprises a belt drive platform 830 enclosing the motor 818 (shown in FIG. 8C), the compression belt 814, and the controller 850 (shown in FIG. 8C). The belt drive platform 830 supports the patient 12 in a substantially supine position, at least during the chest compressions. The compression belt 814 may comprise a load distribution panel 832 and pull straps 834. The pull straps 834 are configured to insert into openings 836 in the belt drive platform 830 on either side of the patient 12. A drive spool (not shown), a motor 818 (shown schematically in FIG. 8C), and associated electrical and mechanical components are disposed within the belt drive platform 830. The pull straps 834 wrap around the drive spool. The motor 818 moves the drive spool such that the pull straps 834 may wrap and unwrap from the drive spool in order for the compression belt 814 to provide and release the chest compressions. As shown in FIG. 8C, the controller 850 of the feedback unit 824, which comprises the processor 852 and memory 854, is electronically connected to the sensors 820, 822, 828 and/or platform 830. The controller 850 can further comprise a communications interface 856 for establishing electronic communication between the feedback unit 824 and/or automated chest compressor 812 and other medical or computer devices at the rescue scene or remote from the rescue scene. For example, the controller 850 may transmit and/or receive information to and/or from an external computing device via the communications interface 856. The processor 852 and/or controller 850 control the motor 818 and the associated electrical and mechanical components to control the chest compressions delivered by the compression belt 814.

In some examples, the displacement sensor 820 is mounted to the compression belt 814, as shown in FIG. 8A. Other sensors, such as the force sensor 822 and physiological sensors 828, may also be coupled to the compression belt 814. In some examples, the sensor 820, 822, 828 may be a component of a defibrillation electrode assembly and/or used in conjunction and/or coordination with a defibrillation electrode assembly. The sensors 820, 822, 828 may send signals indicative of the motion of the chest 14 of the patient 12 to the controller 850 via a wired and/or wireless connection, such as by the wire 858.

With reference to FIG. 8B, a schematic drawing of an automated chest compressor 812 comprising a piston-based device, for providing automated mechanical chest compressions to a patient 12 resting on a backboard 860, is shown. The backboard 860 supports at least the chest 14 of the patient 12 during the chest compressions. The patient 12 is in a substantially supine position at least during the chest compressions.

The piston-based chest compressor 812 comprises a piston 862, a piston driver 864 coupled to the motor 818 (shown in FIG. 8C), support structures 866 for supporting the piston 862 and the piston driver 864, and the compression pad 816 affixed to the piston 862. The support structure 866 can comprise support arms 868 mounted to the backboard 860 and a motor housing 870 suspended above the patient 12 by the support arms 868. As shown in FIG. 8B, one end of the piston 862 is coupled to the motor 818 (shown in FIG. 8C) within the motor housing 870. The compression pad 816 is affixed to an opposite end of the piston 862. The compression pad 816 is in contact with the chest 14 of the patient 12 during chest compressions and decompressions.

The piston-based chest compressor 812 further comprises the controller 850, which can be in the same housing 870 as the motor 818, or in a separate device, such as the feedback unit 824. The controller 850 comprises electronic circuitry, such as the processor 852 and the memory 854 (shown in FIG. 8C). In some examples, the feedback unit 824 comprises a user input panel, status indicators, and/or the display screen 826 for displaying information about operation of the device 812. As in previous examples, the controller 850 is configured to send signals to the motor 818 to control operations of the motor 818 and, in particular, to control movement of the piston 862. For example, the motor 818 may be operatively connected to the piston 862 to drive the piston 862 towards the chest 14 of the patient 12 during downstroke of the chest compressions. The motor 818 further functions to retract the piston 862 away from the chest 14 of the patient 12 during upstrokes of the chest compressions.

In some examples, the system 810 further comprises an adhesive pad 872 releasably adhered to the skin of the patient 12 for insulating the chest 14 from the compression forces of the piston 862 and, particularly, for distributing the forces over a greater area of the chest 14. The adhesive pad 872 can comprise a liner and an adhesive face. The liner can be configured to be removed or peeled away from the adhesive face by the acute care provider (not shown in FIGS. 8A and 8B) in order to attach the adhesive pad 872 to the chest 14 of the patient 12.

During operation of the compressor 812, the compression pad 816 contacts the adhesive pad 872 during performance of the chest compressions. Following completion of the chest compression, the acute care provider 10 may remove the adhesive pad 872, for example, by applying a solvent to the adhesive pad 872 and/or peeling the adhesive pad 872 away from the patient's chest 14. In some examples, one or more of the sensors, such as the displacement sensor 820 and/or force sensor 822, for detecting information about the chest compressions may be mounted to or embedded in the adhesive pad 872. The patient physiological sensors 828 may also be positioned in the adhesive pad 872. The sensors 820, 822, 828 may be coupled to controller 850 via a wired and/or wireless connection, such as a wire 874 extending from the adhesive pad 872 to the feedback unit 824. In some examples, the physiological sensor 828 may be a component of a defibrillation electrode assembly and/or used in conjunction and/or coordination with a defibrillation electrode assembly for providing defibrillation treatment to the patient.

### Automatic Adjustment of Patient-Specific Compression Parameters Based on Measured Force

As previously discussed, the manual or automated chest compression systems can be configured to adjust scheduled values for compression depth and/or rate of the chest compression protocol based on force measurements detected by the force sensors 822. Graphs showing initial chest compression protocols 902a, 902b, 902c, 902d, 902e modified based on the force measurements are shown in FIGS. 9A-9E.

FIG. 9A is a non-limiting example of an initial chest compression protocol 902a modified to include patient-specific depths for some of the scheduled chest compressions. Specifically, a scheduled depth for some chest compressions has been increased to a patient-specific depth in response to a measurement of force. As shown in FIG. 9A, the predetermined initial compression protocol 902a comprises chest compressions with a gradual linear increase in depth at a constant rate, as shown by line segments 914, 916. A displacement graph 904 shows actual depths achieved by the automated chest compressor, such as the compressors 812 shown in FIGS. 8A and 8B. A force graph 906 shows force measurements for the chest compressions performed by the automated chest compressor 812 measured by a force sensor 822. As discussed previously, the force measurements are mathematically related (e.g., proportional) to the chest compliance of the patient 12. As shown by the displacement graph 904, at first, the measured depths gradually increase (as would be expected for the initial compression protocol 902a), while the measured forces in force graph 906 remain about constant. In general, if the forces are too high, there is a risk of harm to the patient 12. If measured forces are too low, it indicates the chest compressions could be deeper, without injuring the patient 12.

With continued reference to FIG. 9A, vertical line 908 represents a point in time in which the measured forces begin a slight downward trend. At a subsequent point in time (shown by vertical line 910), the force measurements have fallen even farther and generally continue in the downward trend. Conversely, over the same period shown by lines 908 and 910, the depth or displacement measurements, shown by displacement graph 904, continue to steadily climb. This drop off in the amount of measured force even as depth increases indicates that the chest compressions could be deeper, which would allow for the final target compression depth 506 to be reached faster.

Accordingly, at the point in time represented by line 910, the processor 852 and memory 854 can be configured to cause the automated chest compressor 812 to adjust the scheduled compression depths for the remaining compressions of the compression protocol from scheduled depths (shown by dashed line 916) to patient-specific depths (shown by line 918) for remaining chest compressions. As shown by the force graph 906, the force measurements begin to increase in response to adjusting the scheduled depths to the patient-specific depths. Adjusting the initial compression protocol 902a to include the patient-specific depths (line 918) causes the initial compression protocol 902a to reach the final target depth (shown by line 920) in a shorter amount of time than provided by the predetermined scheduled depths before the benefit of the force measurements (shown by lines 914 and 916). Beneficially, the shorter initial compression protocol or ramp up period is achieved with minimal risk of injury to the patient 12, as indicated by the force measurements in the force graph 906, while also retaining the structural integrity of the patient's chest 14, which will allow for efficient chest compressions throughout the performance of the chest compressions.

Lastly, after the final target compression depth 920 is reached, at a time shown by the vertical line 912, the force continues to decrease. This decrease in force is expected, as the patient's chest 14 further acclimates to chest compressions applied at the final target compression depth 920. However, as the final target compression depth has already been achieved, the automated chest compressor 812 would not adjust the depth of chest compressions at this point.

FIG. 9B shows another example of an initial compression protocol 902b for a ramp up (or break-in) period, in which a depth of chest compressions increases in response to force measurements. FIG. 9B also includes a displacement graph 926, which shows the measured depths actually achieved by the chest compressor 812 during chest compressions, and a force graph 928, which shows force measurements by the force sensor 822 for each corresponding chest compression.

As shown in FIG. 9B, the initial compression protocol 902b comprises a first portion 930 in which a scheduled depth for the chest compressions increases linearly at a first rate. The predetermined protocol 902b also includes a second portion 932 including scheduled chest compressions that increase at a second rate. The second rate is greater than the first rate. As in the previous examples, scheduled depths for the initial compression protocol 902b are adjusted to patient-specific depths based on the force measurements. The patient-specific depths determined from the force measurements are shown by line segment 934.

As discussed previously, the adjustment from the scheduled depths to the patient-specific depths is based on measured forces shown in the force graph 928 and, in particular, the changes in measured forces at periods of time indicated by vertical lines 938, 940, 942. The vertical line 938 represents a point in time in which the measured forces begin a slight downward trend, as shown in the force graph 928. At a point in time represented by the vertical line 940, the measured force continues to decrease. This decrease or drop-off in the measured force indicates that the chest compressions could still be achieving a deeper compression depth. Accordingly, the processor 852 and memory 854 can be configured to adjust the scheduled target depths for the remaining chest compressions to patient-specific target depths for remaining compressions. Applying chest compressions at the increased patient-specific target depths allows the chest compressor 812 to achieve the final target compression depth, shown by line segment 944, much faster than would have been possible following the predetermined initial compression protocol, shown by segment line 932.

FIG. 9C illustrates an example of an initial compression protocol 902c, where patient-specific depths have been adjusted or recalculated multiple times, as shown by the multiple line segments (e.g., steep segments 944 and gradual segments 946) with different slopes that make up the protocol 902c. In particular, the patient-specific depths have been adjusted so that the final target depth 950 is not achieved too quickly. Instead, by occasionally reducing the slope as shown by gradual segments 946, the protocol 902c reaches the final target compression depth 950 shortly following Timeₘᵢₙ. More specifically, as shown in FIG. 9C, the compression depth for the protocol 902c increases quickly with a steeper slope for short periods of time. As discussed previously, the processor 852 and memory 854 are configured to increase compression depth quicker, over a steeper slope, when measured force is lower than expected and/or lower than predetermined minimum threshold values. However, if the magnitude of compression depth increases at such a steep slope for the entire duration of the protocol 902c, the final target depth 950 would be achieved long before the minimum permissible time, Timeₘᵢₙ. Therefore, the processor 852 and memory 854 are configured to modify the scheduled compression depths to include portions (e.g., the gradual segments 946) where the rate of increase is far lower or nearly non-existent. Including these gradual segments 946 ensures that the final target compression depth 950 is not achieved too quickly.

With reference to FIG. 9D, in some cases, it may not be possible to achieve a final target depth 960 within the initial compression or ramp up period of time of the initial compression protocol 902d. For example, a patient having a barrel chest (e.g., an elderly individual with a high degree of calcification in the sternal cartilage) may exhibit a relatively high stiffness. When the patient's chest does not soften with compressions or otherwise remains stiff, increasing a force of the chest compressions may only result in a minimal increase in chest compression depth. Accordingly, a patient having a stiff chest that is subject to an initial compression protocol may take a longer time to reach the final target depth 960 compared with a patient having a softer or more compliant chest. In some cases, the maximum time Timeₘₐₓ may be reached before the final target depth 960 is achieved. In such situations, as shown in FIG. 9D, once the maximum time Timeₘₐₓ is reached, the ramp up period may conclude and chest compressions may be provided to the patient at the final target depth 960. More specifically, as shown in FIG. 9D, chest compressions are initially applied according to the predetermined initial compression protocol 902d, as shown by line segment 962. However, shortly after initiation of chest compressions, the processor 852 and memory 854 adjust the compression depth from a scheduled compression depth (shown by the dashed line 964) to patient-specific depths for remaining chest compressions, as shown by line segments 966, 968, 970, 972, 974. As shown in FIG. 9D, the rate of increase in compression depth for the patient-specific depths is not large enough to reach the final target compression depth 960 by the maximum permissible time, Timeₘₐₓ. Therefore, near Timeₘₐₓ the processor 852 and memory 854 are configured to increase the compression depth from its current value to the final target depth 960, even though the patient's chest 14 may not be acclimated to such deep compressions.

Adjusting the target compression depth as shown in FIG. 9D seeks to ensure that the final target depth 960 is achieved at the maximum time Timeₘₐₓ or within a predetermined maximum number of chest compressions, even when measured force is higher than expected and/or allowed. This ensures that the patient 12 will begin to receive the benefit of full chest compressions at the final target depth no later than at the time, Timeₘₐₓ. While there is a chance that a drastic increase in compression depth could result in injury to the patient, it is believed that there would be a greater risk to the patient if high quality chest compressions were not initiated by the time Timeₘₐₓ.

In other examples, a more dynamic algorithm may be employed to periodically adjust a slope of the line representing the target compression depths for the initial compression protocol (referred to herein as the “ramp up slope”) so that a drastic jump in the target chest compression depth does not occur at the time Timeₘₐₓ. For example, the processor 852 and memory 854 may be configured to employ a dynamic estimation of the ramp up slope and time to a final target compression depth 980 to provide a smooth transition to the final target depth 980 after the ramp up period. The dynamic estimation of the ramp up slope (shown in FIG. 9E) may involve adjusting to the ramp up slope based on, for example, force, compliance, and/or other parameters (e.g., force gradient, compliance gradient, area under the curve for force-displacement hysteresis cycles). For example, at any given time during the ramp up period, if the time to the final target depth 980 is projected to exceed the Timeₘₐₓ, then a slight increase of the ramp up slope may be implemented, such that when the maximum time limit is reached, a drastic increase in compression depth is not necessary.

As show in FIG. 9E, chest compressions are initially applied according to the predetermined initial compression protocol 902e, as shown by the line 982. However, shortly after initiation of chest compressions, the processor 852 and memory 854 adjust the compression depth from a scheduled compression depth (shown by the dashed line 984a) to a patient-specific depth and ramp up slope (shown by dashed line 984b). The processor 852 then calculates or estimates that performing chest compressions as shown by the dashed line 984b for the remainder of the ramp up period will not achieve the final target depth 980 within the time Timeₘₐₓ. Therefore, after a period of time, the processor 852 and memory 854 are configured to again adjust the ramp up slope to a steeper slope (shown by dashed line 984c), even if the patient's chest is not yet acclimated to chest compressions at the target depth(s) indicated by the dashed line 984b. Chest compressions are performed according to the adjusted slope (dashed line 984c) for a period of time. Compressions could be performed at the adjusted slope (dashed line 984c) for the remainder of the ramp up period, or, after a period of time, the processor 852 and memory 854 may again increase the slope of the line 982 to a steeper slope (as shown in FIG. 9E) to further smooth the transition to the final target depth 980. By periodically adjusting the ramp up slope, the target chest compression depth at Timeₘₐₓ is closer to the final target compression depth 980, than if the ramp up slope were not periodically adjusted. Therefore, the transition from the initial compression protocol 202e to the final compression depth 980 in FIG. 9E is smoother than in the exemplary protocol 202d of FIG. 9D, which includes a large instantaneous increase in the target compression depth at Timeₘₐₓ.

Methods for Implementing Initial Compression Protocols with Automated Chest Compressors

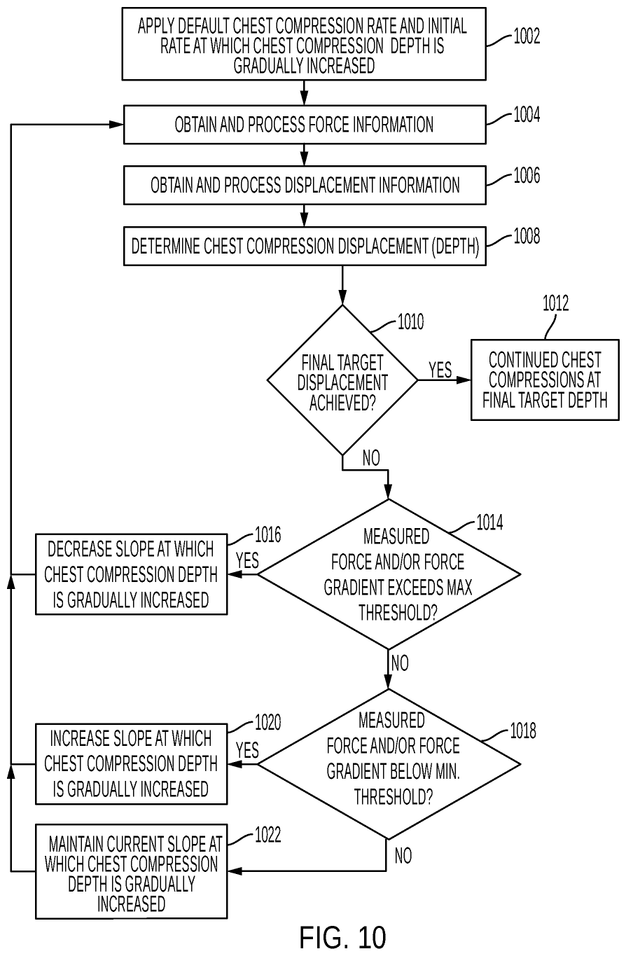

FIG. 10 is a flowchart showing an example of how scheduled compression depths of an initial compression protocol 902a, 902b, 902c, 902d, 902e may be gradually increased to patient-specific compression depths, as implemented in conjunction with an automated chest compressor, such as the automated chest compressors 812 shown in FIGS. 8A and 8B.

With reference to FIG. 10, at step 1002, the automated chest compressor 812 is initially configured to provide chest compressions at a default chest compression rate/frequency and initial chest compression depth according to a predetermined initial compression protocol. Force measurements for the initial chest compressions are obtained by the force sensor 822 and provided to the controller 850 (e.g., processor 852 and memory 854) of the automated chest compression system 810 at step 1004. Similarly, at step 1006, displacement measurements (e.g., measurements for actual displacement of the patient's chest) from the displacement or depth sensor 822 are obtained and processed. At step 1008, the processed displacement information is used to determine compression depth for chest compressions performed by the automated chest compressor 812. At step 1010, the determined compression depth is compared to a final target compression depth to determine whether the final target displacement depth has been achieved. As discussed previously, the final target compression depth can be a depth recommended for standard chest compressions, such as a depth of about 2.0 inches to 2.4 inches, pursuant to the 2015 AHA guidelines, or another suitable target compression depth according to a different standard. If the final target compression depth is achieved, then the processor 852 and memory 854 are configured to cause the chest compressor 812 to continue to perform chest compressions at the final target depth for a predetermined or indeterminate amount of time, at step 1012.

Conversely, if the final target compression depth is not yet achieved, at step 1014, the processor 852 and memory 854 are configured to compare the measured force and/or a change in the measured force (e.g., the force gradient) for preceding chest compressions to a respective maximum threshold force and/or force gradient. The maximum threshold force and/or force gradient can be a maximum amount of force or maximum gradient that can be safely applied to the patient's chest 14 without causing injury to the patient 12. If the measured force and/or force gradient exceeds the maximum threshold force, force gradient, or combination thereof, the processor 852 and memory 854 are configured to decrease the magnitude of scheduled compression depths to patient-specific depths for the remaining compressions of the initial compression protocol 902a, 902b, 902c, 902d. For example, the processor 852 and memory 854 may decrease a rate (e.g., slope of the line representing the initial compression protocol) at which the target depth gradually increases for remaining compressions of the initial compression protocol 902a, 902b, 902c, 902d, as shown at step 1016.

If the measured compression force and/or force gradient for the preceding chest compression does not exceed the respective maximum threshold force and/or force gradient, at step 1018, the processor 852 and memory 854 then compare the measured force and/or force gradient to a respective minimum threshold force and/or force gradient. As discussed previously, applying chest compressions below the minimum threshold force and/or force gradient may be undesirable, since compression depth could be increased to achieve the final compression depth more quickly, without causing injury to the patient 12. If the measured force and/or force gradient is less than the respective minimum threshold force and/or force gradient, the processor 852 and memory 854 are configured to increase the scheduled compression depth to deeper patient-specific compression depths for the remaining chest compressions of the initial compression protocol 902a, 902b, 902c, 902d, 902e. For example, at step 1020, the processor 852 and memory 854 may be configured to increase a rate/slope at which the patient-specific compression depth gradually increases for the remaining chest compression of the initial compression protocol 902a, 902b, 902c, 902d, 902e. Conversely, if the measured force and/or force gradient for the preceding chest compressions is not less than the respective minimum threshold force and/or force gradient, the processor 852 and memory 854 may not adjust scheduled depths for the chest compressions of the initial compression protocol 902a, 902b, 902c, 902d, 902e and, instead, at step 1022, cause the automated chest compressor 812 to continue applying chest compressions according to the chest compression protocol 902a, 902b, 902c, 902d, 902e.

As shown in FIG. 10, the processor 852 and memory 854 are configured to cause the automated chest compressor 812 to continue performing steps 1004 through 1022 until the final target depth is achieved, at step 1010. Once the final target depth is achieved, at step 1012, as discussed previously, the processor 852 and memory 854 can cause the automated chest compressor 812 to continue applying chest compressions at the final target depth for a predetermined or indeterminate amount of time.

While not shown in FIG. 10, in some examples, the processor 852 and memory 854 may be configured to consider a number of compressions previously applied to the patient and/or the time boundaries (e.g., the minimum time Timeₘᵢₙ and the maximum time Timeₘₐₓ) when controlling adjustment of the patient-specific depths and controlling the automated chest compressor 812. For example, the processor 852 and memory 854 may not increase the scheduled compression depth every time that a measured force for a compression is below the minimum threshold in order to avoid reaching the final target depth too quickly (e.g., in less time than the minimum time Timeₘᵢₙ or a minimum number of compressions for completing the initial compression protocol) as shown, for example, in the protocol 902c in FIG. 9C. Similarly, the processor 852 and memory 854 may be configured to cause the automated chest compressor 812 to begin applying chest compressions at the final target compression depth after the maximum period of time Timeₘₐₓ or maximum number of chest compressions for completing the initial compression protocol have been provided as shown, for example, by the exemplary protocol 902d in FIG. 9D.

### Computing Devices and Computer Systems

As will be appreciated by those skilled in the art, the processes and methods for implementing initial compression protocols and for determining patient-specific compression depths described herein can be implemented in digital electronic circuitry, or in computer hardware, firmware, and/or software. Further, features of the apparatuses described herein, including ACD devices, automated chest compressors, feedback units, medical devices, and chest compression feedback devices, can be implemented in a computer program product tangibly embodied in an information carrier, e.g., in a machine-readable storage device for execution by a programmable processor; and method steps can be performed by a programmable processor executing a program of instructions to perform functions of the described implementations by operating on input data and generating output. The described features can also be implemented advantageously in one or more computer programs that are executable on a programmable system including at least one programmable processor coupled to receive data and instructions from, and to transmit data and instructions to, a data storage system, at least one input device, and at least one output device.

Some of the configurations described herein are described as a process depicted as a flow diagram or block diagram. Although each flow diagram or block diagram may describe the operations as a sequential process, many of the operations can be performed in parallel or concurrently. In addition, the order of the operations may be rearranged. A process may have additional stages or functions not included in the figures. Furthermore, examples of the methods may be implemented by hardware, software, firmware, middleware, microcode, hardware description languages, or any combination thereof. When implemented in software, firmware, middleware, or microcode, the program code or code segments to perform the tasks may be stored in a non-transitory processor-readable medium such as a storage medium. Processors may perform the described tasks.

In the figures, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the scope of the disclosure.

The computer memory described herein can refer to internal computer memory, such as dynamic computer memory, as well as to computer storage devices and systems, as are known in the art. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. Common forms of physical and/or tangible processor-readable may further comprise a floppy disk, a flexible disk, hard disk, magnetic tape, or any other magnetic medium, a CD-ROM, any other optical medium, punch cards, paper tape, any other physical medium with patterns of holes, a RAM, a PROM, EPROM, a FLASH-EPROM, any other memory chip or cartridge, a carrier wave as described hereinafter, or any other medium from which a computer can read instructions and/or code.

The controllers and processors disclosed herein may be part of a computer system that includes a back-end component, such as a data server, or that includes a middleware component, such as an application server or an Internet server, or that includes a front-end component, such as a client computer having a graphical user interface or an Internet browser, or any combination of them. The components of the systems described herein can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet. The computer system can include clients and servers. A client and server are generally remote from each other and typically interact through a network, such as the described one. The relationship of client and server arises by virtue of computer programs running on the respective computers and having a client-server relationship to each other.

Having described several example configurations, various modifications, alternative constructions, and equivalents may be used without departing from the disclosure. For example, the above elements may be components of a larger system, wherein other rules may take precedence over or otherwise modify the application of aspects of the present disclosure. Also, a number of operations may be undertaken before, during, or after the above elements are considered. Also, technology evolves and, thus, many of the elements are examples and do not bound the scope of the disclosure or claims. Accordingly, the above description does not bound the scope of the claims.

### Examples

The following experimental examples are presented to demonstrate the general principles of embodiments of the present disclosure. The present disclosure should not be considered as limited to the specific examples presented. These experimental examples show how a series of initial chest compressions impact different patients. Differences in force and depth measurements for initial chest compressions show differences in how patients' chests acclimate to the chest compressions. These experimental measurements demonstrate the need for providing an initial compression or ramp up period for chest compressions, as provided by the methods and systems disclosed herein.

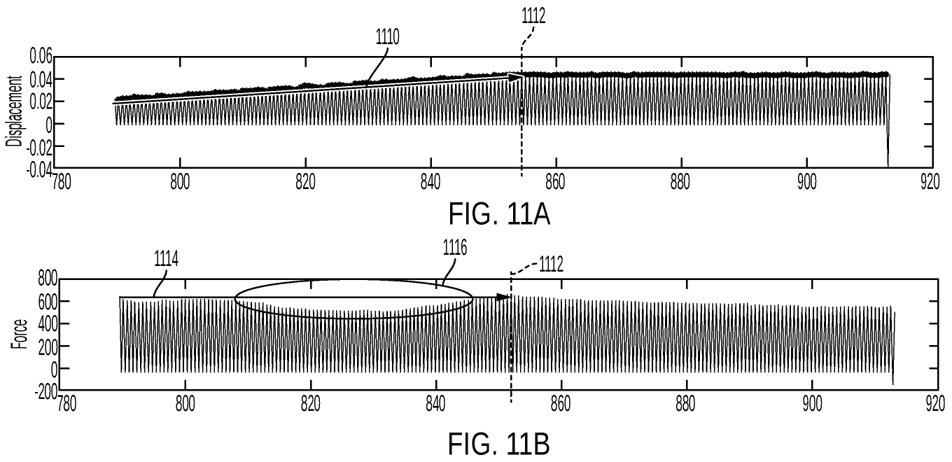

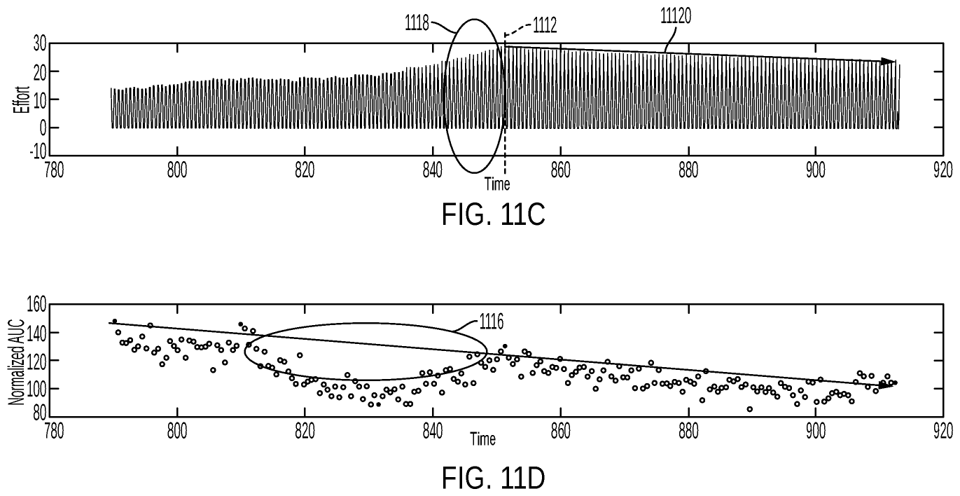

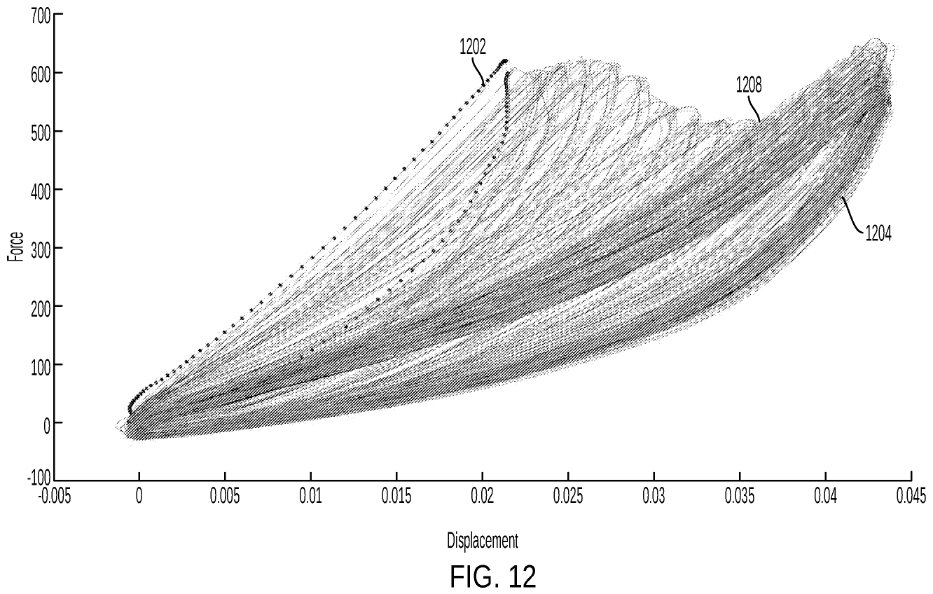

FIGS. 11A-11D are time-domain graphs showing displacement, force, effort (product of force and displacement), and an area-under-the-curve (for force-displacement hysteresis cycles, such as those displayed in FIG. 12) for chest compressions performed during an initial compression period for a patient. As shown in FIG. 11A, displacement for the chest compressions gradually increases, as shown by line 1110, until the final target depth is achieved, as shown by the point in time represented by line 1112. As shown by the measurements in FIG. 11B, force for an initial group of chest compressions generally remains constant, even as displacement gradually increases, as shown by the line 1114. After a period of time, force begins to decrease as shown by the oval 1116, even as displacement continues to increase. It is believed that this decrease in force occurs as the patient's chest acclimates to the chest compressions. Further, this area of reduced force would be a period of time in which chest compression depth could be increased faster, to achieve the final target depth more quickly. After a period of time, the continued gradual increase in displacement causes the measured force to increase closer to the initial measured force values. Once the final target depth is reached (shown by line 1112), the force continues to gradually decrease as the patient's chest acclimates to chest compressions at the final target compression depth. FIG. 11D is a graph showing an area under the curve (AUC) for force-displacement hysteresis plots. The AUC graph more clearly depicts the period of time, shown by shape 1116, where force is low and where chest compressions of increased depth could have been performed without causing injury to the patient.

FIG. 11C is a graph for effort, which is calculated based on the instantaneous measurement force multiplied by the corresponding instantaneous measurement of displacement over time. As shown in FIG. 11C, effort for the initial group of chest compressions is rather low, since the magnitude of displacement is low. Effort gradually increases as displacement increases, but remains relatively low due to the slight decrease in force which occurs as the patient's chest acclimates to the chest compressions. However, as shown by compressions enclosed in shape 1118, effort increases rapidly near the end of the initial compression protocol or ramp up period. Effort is greatest when the final target depth is first achieved, as shown by the line 1112. Effort gradually decreases as chest compressions at the final target depth are provided, as shown by line 1120, due to the decrease in force which occurs as the patient's chest acclimates to the chest compressions performed at the final target depth.

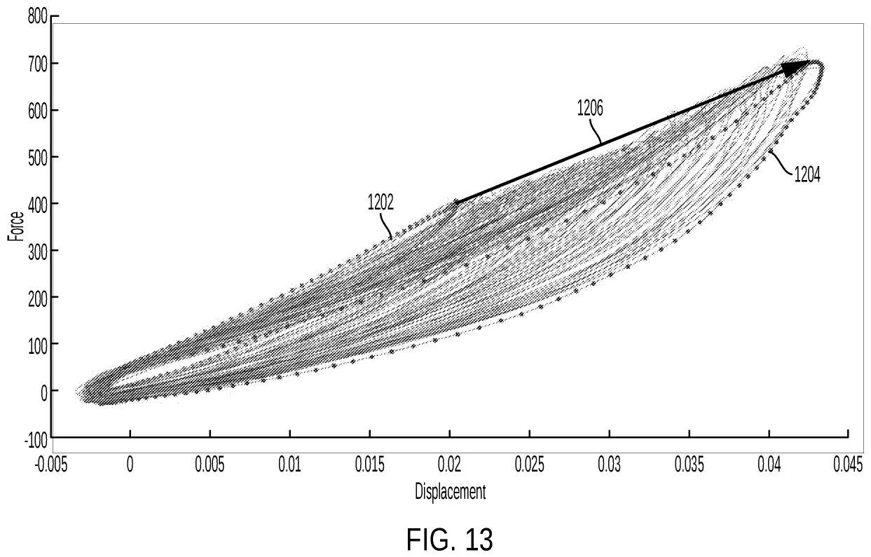

FIGS. 12 and 13 are graphs of force-displacement cycles on a per-compression basis, shown by compression loops 1202, 1204, during an initial compression period or ramp up period for different patients. The compression loops 1202, 1204 show the relationship between the chest compression displacement (in meters) and the force applied (in Newtons).

The graphs in FIGS. 12 and 13 show differences in how patients adapt or acclimate to chest compressions highlighting a need for performance of chest compressions at patient-specific depths during the initial chest compression period or ramp up period. The graphs show an initial compression protocol in which compression depth gradually increases from an initial compression 1202 to a final compression 1204. These are standard chest compressions with no lift or decompression portion.

FIG. 12 shows a chest that acclimates quickly to chest compressions, meaning that the gradual increase in chest compression depth of the initial protocol is insufficient. As shown in FIG. 12, the force (y-axis) initially decreases, even as displacement increases. Consequently, when the force measurements decrease, the automated chest compressor could have increased compression depth in order to reach the final chest compression depth faster without injuring the patient. As shown in FIG. 12, the patient's chest becomes broken in at a boundary between spaced apart loops and loops that are clustered together. This boundary is shown generally by reference number 1208 in FIG. 12, and represents an end or completion of the ramp up period for chest compressions.

Conversely, FIG. 13, which shows chest compressions applied to a different patient, illustrates a relatively ideal scenario in which displacement and force increase on a relatively linear progression, as shown by line 1206, from a starting displacement, at loop 1202, towards the final chest compression depth, shown by loop 1204. In this scenario, appropriate force was provided by the automated chest compressor throughout the initial chest compression period or ramp up period. Therefore, no adjustment to the predetermined or initial compression protocol may have been required for this patient.

1. A system for administering patient-specific chest compressions to a patient, the system comprising:
an automated chest compressor configured to be applied to the chest of the patient to administer chest compressions to the patient;
at least one force sensor configured to sense force information for force exerted on the patient by the chest compressor from the applied chest compressions; and
at least one processor and memory communicatively coupled with the chest compressor and the at least one force sensor, wherein the at least one processor and memory are configured to:
control the chest compressor to administer the chest compressions over an initial compression period according to an initial compression protocol, the initial compression protocol comprising a plurality of chest compressions of increasing scheduled depths with a first compression at an initial depth and a final compression at a final target depth greater in magnitude than the initial depth,
receive and process the sensed force information to estimate force applied to the chest during the chest compressions, and
adjust a magnitude of the scheduled depths to patient-specific depths for one or more remaining chest compressions of the plurality of chest compressions of the initial compression protocol based on the estimated force applied to the chest during one or more preceding chest compressions of the plurality of chest compressions.

2. The system of claim 1, wherein the initial compression protocol comprises at least a first portion of the plurality of chest compressions in which the scheduled depth of the chest compressions increases at a first rate.

3. The system of claim 2, wherein the initial compression protocol comprises at least a second portion of the plurality of chest compressions in which the scheduled depths of the chest compressions increase at a second rate, the second rate being different from the first rate.

4. The system of claim 3, wherein the second rate is greater than the first rate.

5. The system of claim 1, wherein the adjustment of the magnitude of the scheduled depths to the patient-specific depths for the one or more remaining chest compressions occurs at regular intervals.

6. The system of claim 1, wherein the initial compression protocol comprises a continuous linear increase in the scheduled depths over the initial compression period.

7. The system of claim 1, wherein the adjustment in the magnitude of the scheduled depths to the patient-specific depths of the one or more remaining chest compressions comprises a decrease of the scheduled depths for at least one of the one or more remaining chest compressions.

8. The system of claim 1, wherein the adjustment of the magnitude of the scheduled depths to the patient-specific depths for the one or more remaining chest compressions is further based, at least in part, on a number of the preceding chest compressions already provided to the patient.

9. The system of claim 1, wherein the at least one processor and memory are further configured to control the chest compressor to repeatedly administer chest compressions at the final target depth, once the adjusted patient-specific depths reaches the final target depth or following the plurality of chest compressions of the initial compression protocol.

10. The system of claim 1, wherein the initial compression period comprises a period of time of about 30 seconds to about 5 minutes.

11. The system of claim 1, wherein the initial compression period comprises a period of time of about 1 minute to about 2 minutes.

12. The system of claim 1, wherein the adjustment in the magnitude of the scheduled depths to the patient-specific depths is based on whether the estimated force falls outside of an expected range.

13. The system of claim 12, wherein determination of whether the estimated force falls outside of the expected range comprises determination of whether the estimated force exceeds a predetermined force threshold.

14. The system of claim 1, wherein the at least one processor and memory are further configured to control the chest compressor to administer the chest compressions according to one or more additional patient-specific compression parameters over the initial compression period.

15. The system of claim 14, wherein the one or more patient-specific compression parameters comprise at least one of: compression force, compression hold time, release velocity, downstroke acceleration, downstroke velocity, lift displacement, lift force, upstroke acceleration, and upstroke velocity.

16. The system of claim 1, further comprising at least one displacement sensor configured to sense displacement signals corresponding to displacement of the patient's chest during the applied chest compressions, wherein the at least one processor and memory are configured to receive and process the displacement signals to estimate displacement of the chest during the chest compressions.

17. The system of claim 16, wherein the adjustment of the magnitude of the scheduled depths to the patient-specific depths for one or more remaining chest compressions of the plurality of chest compressions is based, at least in part, on the estimated displacement.

18. The system of claim 16, wherein the adjustment in the magnitude of the scheduled depths to the patient-specific depths for the one or more remaining chest compressions of the plurality of chest compressions is based, at least in part, on estimated chest compliance over the one or more preceding chest compressions.

19. The system of claim 18, wherein the estimated chest compliance is based on the estimated force and the estimated displacement.

20. The system of claim 1, wherein the adjustment in the magnitude of the scheduled depths to the patient-specific depths for the one or more remaining chest compressions of the plurality of chest compressions comprises a non-linear increase in compression depths for the one or more remaining chest compressions based on an increase or decrease in an estimated chest compliance over the one or more preceding chest compressions.

21. The system of claim 1, wherein the adjustment in the magnitude of the scheduled depths to the patient-specific depths for the one or more remaining chest compressions of the plurality of chest compressions comprises a substantially linear increase in compression depths for the one or more remaining chest compressions.

22. The system of claim 1, wherein the initial depth comprises a depth of about 0.1 inch to about 1.0 inch.

23. The system of claim 1, wherein the target final depth comprises a depth of about 2.0 inches to about 2.4 inches.

24. The system of claim 1, wherein the initial compression protocol comprises a first portion comprising chest compressions of the initial depth, a second portion comprising chest compressions of at least one intermediate depth between the initial depth and the final target depth, and a third portion comprising chest compressions at the final target depth.

25. The system of claim 24, wherein the at least one intermediate depth comprises a depth of about 0.5 inch to about 2.0 inches.

26. The system of claim 1, wherein the chest compressor is configured to provide active compression/decompression treatment to the chest of the patient.

27. The system of claim 1, wherein the chest compressor comprises a compression belt and a belt tensioner configured to tighten the compression belt around the chest of the patient in order to compress the chest of the patient.

28. The system of claim 1, wherein the chest compressor is a piston-based system that comprises:
a piston,
a piston driver,
support structures for supporting the piston and the piston driver, and
a compression pad affixed to the piston.

29-109. (canceled)
